(19) United States
(12) Patent Application Publication
(10) Pub. No.: US 2010/0125495 A1
(43) Pub. Date: May 20, 2010

(54) SYSTEM AND METHOD OF PROVIDING A MOBILE WALLET AT A MOBILE TELEPHONE

(76) Inventors: Steven M. Smith, Cumming, GA (US); Brady L. Rackley, Atlanta, GA (US); Ben D. Ackerman, Atlanta, GA (US); Nanci Rainey, Atlanta, GA (US); Warren D. Porter, Atlanta, GA (US); Aidoo Osei, Atlanta, GA (US); Robert L. Dessert, Atlanta, GA (US); Karthik R. Iyer, Atlanta, GA (US); Kyle Cochran, Atlanta, GA (US); James P. Mason, Atlanta, GA (US); Scott P. Monahan, Atlanta, GA (US)

Correspondence Address: QUALCOMM INCORPORATED, 5775 MOREHOUSE DR., SAN DIEGO, CA, 92121, US

(21) Appl. No.: 12/562,576

(22) Filed: Sep. 18, 2009

Related U.S. Application Data
(60) Provisional application No. 61/115,453, filed on Nov. 17, 2008.
(60) Provisional application No. 61/115,454, filed on Nov. 17, 2008.

(51) Int. Cl. G06Q 30/00; G06Q 40/00

(52) U.S. Cl. 705/14.23; 705/30; 705/26; 705/35

(57) ABSTRACT

A method of providing a mobile wallet is disclosed and may include displaying a mobile wallet login screen and displaying a mobile wallet. The mobile wallet includes at least one of the following: an accounts option, a buy now option, an offers option, a receipts option, and a more option. The method further includes displaying one or more accounts when the accounts option is selected. The one or more accounts may include at least one of the following: a bank account, a credit account, a gift card account, and a rewards account.

### RELATED APPLICATIONS

The present application claims priority to and incorporates by reference in its entirety U.S. Provisional Patent Application Ser. No. 61/115,453, entitled SYSTEM AND METHOD OF PROVIDING A MOBILE WALLET AT A MOBILE TELEPHONE, filed on Nov. 17, 2008. Further, the present application claims priority to and incorporates by reference in its entirety U.S. Provisional Patent Application Ser. No. 61/115,454, entitled SYSTEM AND METHOD OF CONDUCTING TRANSACTIONS USING A MOBILE WALLET SYSTEM, filed on Nov. 17, 2008. The present application incorporates by reference U.S. patent application Ser. No. ______ (Attorney Docket No. 090666U2) entitled SYSTEM AND METHOD OF CONDUCTING TRANSACTIONS USING A MOBILE WALLET SYSTEM, filed on ______.

### FIELD

The present invention generally relates to managing multiple accounts, and more particularly, to managing multiple accounts via a mobile telephone.

### DESCRIPTION OF THE RELATED ART

Typically, a person may have multiple bank accounts, multiple credit card accounts, gift card accounts, etc. Each account provider may provide online access to each account and a customer may manage each account separately via a separate online portal. When a customer is actually shopping, e.g., at a traditional brick-and-mortar store or electronically, i.e., online or via a mobile telephone network, the customer may not have ready access to particular account details. Further, when using a mobile telephone to shop at a mobile store provided via a mobile telephone network, the shopping process and the checkout process may be relatively time consuming. This experience may be quite negative and may cause a customer to not further utilize the mobile store.

Accordingly, what is needed is an improved system and method of managing multiple accounts via a mobile telephone.

### SUMMARY OF THE DISCLOSURE

A method of providing a mobile wallet is disclosed and may include displaying a mobile wallet login screen and displaying a mobile wallet. The mobile wallet includes at least one of the following: an accounts option, a buy now option, an offers option, a receipts option, and a more option. The method further includes displaying one or more accounts when the accounts option is selected. The one or more accounts may include at least one of the following: a bank account, a credit account, a gift card account, and a rewards account.

The method may also include displaying account details when the one or more accounts is selected, displaying a buy now input screen when the buy now option is selected, and receiving a buy now code. Moreover, the method may include displaying at least one featured product and at least one featured gift card, when a correct buy now code is received.

Further, the method may include displaying one or more offers when an offer is received, providing a save offer option, and adding an offer to a saved list, when the save offer option is selected. The method may also include displaying one or more receipts, when the receipts option is selected and displaying one or more receipt details, when a receipt is selected. Additionally, the method may include displaying a carrier option, a coupons option, a messages option, a send money option, a profile option, a purchases option, a providers option, a where option, or a combination thereof, when the more option is selected.

In another aspect, a device is disclosed and may include means for displaying a mobile wallet login screen and means for displaying a mobile wallet, wherein the mobile wallet includes at least one of the following: an accounts option, a buy now option, an offers option, a receipts option, and a more option. The device may also include means for displaying one or more accounts when the accounts option is selected. The one or more accounts include at least one of the following: a bank account, a credit account, a gift card account, and a rewards account.

In this aspect, the device may also include means for displaying account details when the one or more accounts is selected, means for displaying a buy now input screen when the buy now option is selected, and means for receiving a buy now code. Further, the device may include means for displaying at least one featured product and at least one featured gift card, when a correct buy now code is received. The device may also include means for displaying one or more offers when an offer is received, means for providing a save offer option, and means for adding an offer to a saved list, when the save offer option is selected.

In this aspect, the device may include means for displaying one or more receipts, when the receipts option is selected and means for displaying one or more receipt details, when a receipt is selected. Further, the device may include means for displaying a carrier option, a coupons option, a messages option, a send money option, a profile option, a purchases option, a providers option, a where option, or a combination thereof, when the more option is selected.

In yet another aspect, a device is disclosed and may include a processor. The processor may be operable to display a mobile wallet login screen and to display a mobile wallet. The mobile wallet includes at least one of the following: an accounts option, a buy now option, an offers option, a receipts option, and a more option. In this aspect, the processor is further operable to display one or more accounts when the accounts option is selected. The one or more accounts may include at least one of the following: a bank account, a credit account, a gift card account, and a rewards account.

The processor may further be operable to display account details when the one or more accounts is selected. Also, the processor may be operable to display a buy now input screen when the buy now option is selected and receive a buy now code. The processor may also be operable to display at least one featured product and at least one featured gift card, when a correct buy now code is received. Additionally, the processor may be operable to display one or more offers when an offer is received, provide a save offer option, and add an offer to a saved list, when the save offer option is selected.

In this aspect, the processor is operable to display one or more receipts, when the receipts option is selected and to display one or more receipt details, when a receipt is selected. Further, the processor is operable to display a carrier option, a coupons option, a messages option, a send money option, a profile option, a purchases option, a providers option, a where option, or a combination thereof, when the more option is selected.

In another aspect, a computer program product is disclosed and may include a computer readable-medium. The computer readable-medium may include at least one instruction for displaying a mobile wallet login screen and at least one instruction for displaying a mobile wallet, wherein the mobile wallet includes at least one of the following: an accounts option, a buy now option, an offers option, a receipts option, and a more option. The computer-readable medium may also include at least one instruction for displaying one or more accounts when the accounts option is selected. The one or more accounts include at least one of the following: a bank account, a credit account, a gift card account, and a rewards account.

In this aspect, the computer-readable medium may also include at least one instruction for displaying account details when the one or more accounts is selected, at least one instruction for displaying a buy now input screen when the buy now option is selected, and at least one instruction for receiving a buy now code. Further, the computer-readable medium may include at least one instruction for displaying at least one featured product and at least one featured gift card, when a correct buy now code is received. The computer-readable medium may also include at least one instruction for displaying one or more offers when an offer is received, at least one instruction for providing a save offer option, and at least one instruction for adding an offer to a saved list, when the save offer option is selected.

In this aspect, the computer-readable medium may include at least one instruction for displaying one or more receipts, when the receipts option is selected and at least one instruction for displaying one or more receipt details, when a receipt is selected. Further, the computer-readable medium may include at least one instruction for displaying a carrier option, a coupons option, a messages option, a send money option, a profile option, a purchases option, a providers option, a where option, or a combination thereof, when the more option is selected.

### BRIEF DESCRIPTION OF THE DRAWINGS

In the figures, like reference numerals refer to like parts throughout the various views unless otherwise indicated.

FIG. 1 is a diagram of a mobile wallet system;

FIG. 2 is a diagram of a wireless telephone;

FIG. 3 is a flowchart illustrating a method of aggregating account information;

FIG. 4 is a flowchart illustrating a first portion of a method of providing a mobile wallet at a mobile device;

FIG. 5 is a flowchart illustrating a second portion of a method of providing a mobile wallet at a mobile device;

FIG. 6 is a flowchart illustrating a third portion of a method of providing a mobile wallet at a mobile device;

FIG. 7 is a flowchart illustrating a fourth portion of a method of providing a mobile wallet at a mobile device;

FIG. 8 is a flowchart illustrating a fifth portion of a method of providing a mobile wallet at a mobile device;

FIG. 9 is a flowchart illustrating a sixth portion of a method of providing a mobile wallet at a mobile device;

FIG. 10 is a flowchart illustrating a seventh portion of a method of providing a mobile wallet at a mobile device;

FIG. 11 is a flowchart illustrating an eighth portion of a method of providing a mobile wallet at a mobile device;

FIG. 12 is a flowchart illustrating a ninth portion of a method of providing a mobile wallet at a mobile device;

FIG. 13 is a flowchart illustrating a tenth portion of a method of providing a mobile wallet at a mobile device;

FIG. 14 is a diagram of a touch screen mobile device;

FIG. 15 is a diagram of a mobile wallet login screen;

FIG. 16 is a diagram of a my accounts screen;

FIG. 17 is a diagram of an account details screen;

FIG. 18 is a diagram of a credit accounts screen;

FIG. 19 is a diagram of a gift card accounts screen;

FIG. 20 is a diagram of a reward accounts screen;

FIG. 21 is a diagram of a buy now code input screen;

FIG. 22 is a diagram of a buy now screen;

FIG. 23 is a diagram of a gift cards screen;

FIG. 24 is a diagram of a merchants screen;

FIG. 25 is a diagram of a category screen;

FIG. 26 is a diagram of an occasion screen;

FIG. 27 is a diagram of a detailed gift card screen;

FIG. 28 is a diagram of a checkout screen;

FIG. 29 is a diagram of a contacts screen;

FIG. 30 is a diagram of a messages screen;

FIG. 31 is a diagram of a payment accounts screen;

FIG. 32 is a diagram of another checkout screen;

FIG. 33 is a diagram of an offers screen;

FIG. 34 is a diagram of a features offers screen;

FIG. 35 is a diagram of a detailed offer screen;

FIG. 36 is a diagram of a receipts screen;

FIG. 37 is a diagram of a detailed receipt screen;

FIG. 38 is a diagram of another detailed receipt screen;

FIG. 39 is a diagram of a more screen;

FIG. 40 is a diagram of a carrier screen;

FIG. 41 is a diagram of a bill pay screen;

FIG. 42 is a diagram of a coupons screen;

FIG. 43 is a diagram of a detailed coupon screen;

FIG. 44 is a diagram of a messages screen;

FIG. 45 is a diagram of a detailed message screen;

FIG. 46 is a diagram of another detailed message screen;

FIG. 47 is a diagram of yet another detailed message screen;

FIG. 48 is a diagram of a send money screen;

FIG. 49 is a diagram of a pay bills screen;

FIG. 50 is a diagram of a my profile screen;

FIG. 51 is a diagram of a preferences screen;

FIG. 52 is a diagram of a purchases screen;

FIG. 53 is a diagram of a detailed purchase screen;

FIG. 54 is a diagram of a my providers screen;

FIG. 55 is a diagram of an all providers screen;

FIG. 56 is a diagram of a merchants screen;

FIG. 57 is a diagram of a detailed provider screen;

FIG. 58 is a diagram of a restaurant providers screen;

FIG. 59 is a diagram of a map screen;

FIG. 60 is a diagram of a where screen; and

FIG. 61 is a diagram of a find restaurant screen;

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, the terms “communication device,” “wireless device,” “wireless telephone,” “wireless communications device,” and “wireless handset” are used interchangeably. With the advent of third generation (3G) wireless technology, more bandwidth availability has enabled more electronic devices with wireless capabilities. Therefore, a wireless device could be a cellular telephone, a pager, a PDA, a smartphone, a navigation device, or a computer with a wireless connection.

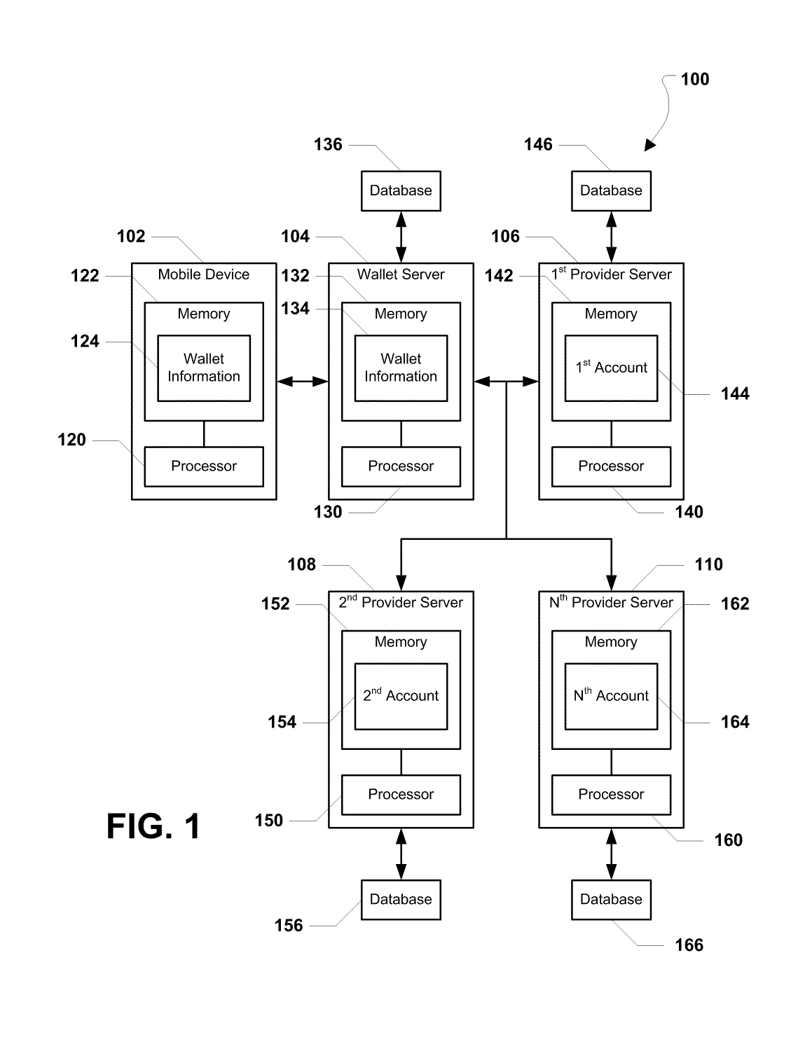

Referring initially to FIG. 1, a mobile wallet system is shown and is generally designated 100. As shown, the system includes a mobile device 102, e.g., a mobile telephone, a portable digital assistant (PDA), or some other portable device. The system 100 also includes a wallet server 104 connected to the mobile device 102. For example, the wallet server 104 may be connected to the mobile device 102 via a wireless network. The wireless network may be a cellular, or mobile, telephone network.

FIG. 1 illustrates that a first provider server 106 may be connected to the wallet server 104. Further, a second provider server 108 and an Nth provider server 110 may be connected to the wallet server 104. In a particular embodiment, the provider servers 106, 108, 110 may be connected to the wallet server 104 via a network, e.g., the Internet.

The mobile device 102 may include a processor 120 and a memory 122 coupled to the processor 120. The memory 122 may include one or more of the method steps described herein. Further, the processor 120 and the memory 122 may serve as a means for executing one or more of the method steps described herein. As indicated, the memory 122 may also include a mobile wallet 124. The mobile wallet may be provided to the mobile device 102 by the wallet server 104.

FIG. 1 shows that the wallet server 104 may include a processor 130 and a memory 132 coupled to the processor 130. The memory 132 may include one or more of the method steps described herein. Further, the processor 130 and the memory 132 may serve as a means for executing one or more of the method steps described herein. As illustrated, the memory 132 may include a mobile wallet 134. The mobile wallet 134 within the wallet server 104 may be similar to the mobile wallet 124 stored within the mobile device 102. Further, the mobile wallet 134 within the wallet server 104 may include substantially the same information as the mobile wallet 124 stored within the mobile device 102. A database 136 may also be connected to the wallet server 104. The database 136 may include one or more other mobile wallets associated with other mobile devices.

As depicted in FIG. 1, the first provider server 106 may include a processor 140 and a memory 142 coupled to the processor 140. The memory 142 may include one or more of the method steps described herein. Further, the processor 140 and the memory 142 may serve as a means for executing one or more of the method steps described herein. As illustrated, the memory 142 may include a first user account 144 associated with a user, or subscriber, of the mobile device 102. A database 146 may also be connected to the wallet server 104. The database 146 may include account information associated with the first user account 144 and account information associated with other user accounts associated with other mobile devices.

The second provider server 108 may include a processor 150 and a memory 152 coupled to the processor 150. The memory 152 may include one or more of the method steps described herein. Further, the processor 150 and the memory 152 may serve as a means for executing one or more of the method steps described herein. As illustrated, the memory 152 may include a second user account 154 associated with a user of the mobile device 102. A database 156 may also be connected to the wallet server 104. The database 156 may include account information associated with the second user account 154 and account information associated with other user accounts associated with other mobile devices.

As illustrated in FIG. 1, the third provider server 110 may include a processor 160 and a memory 162 coupled to the processor 160. The memory 162 may include one or more of the method steps described herein. Further, the processor 160 and the memory 162 may serve as a means for executing one or more of the method steps described herein. As illustrated, the memory 162 may include a third user account 164 associated with a user of the mobile device 102. A database 166 may also be connected to the wallet server 104. The database 166 may include account information associated with the third user account 164 and account information associated with other user accounts associated with other mobile devices.

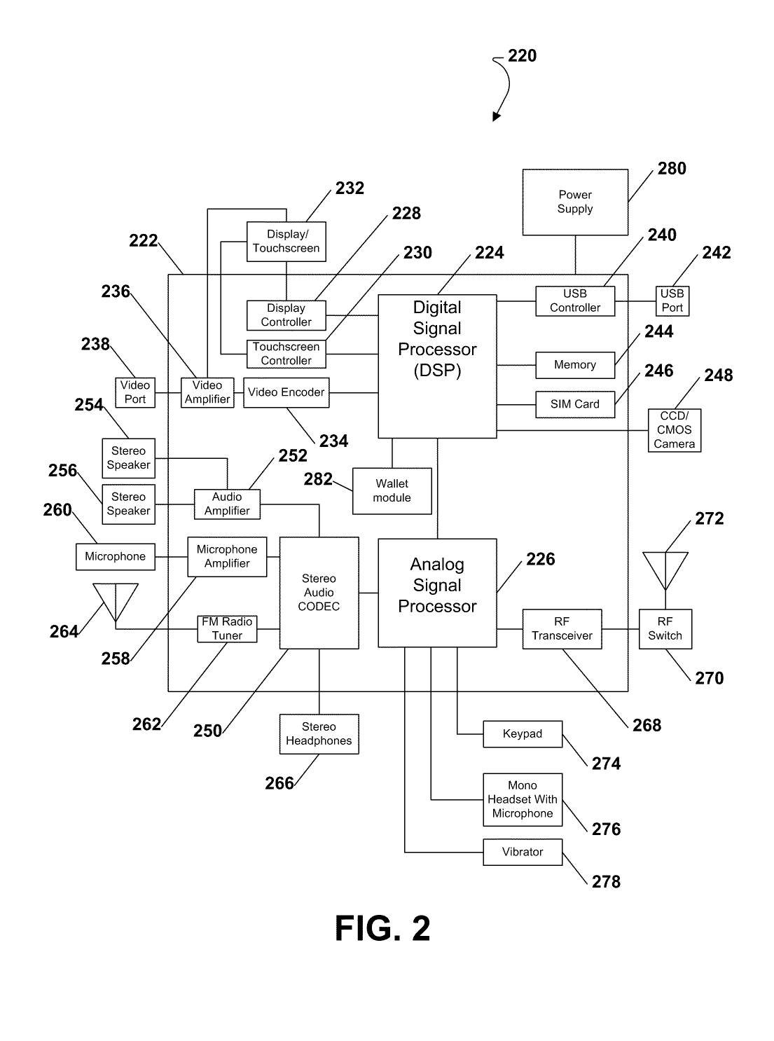

Referring to FIG. 2, an exemplary, non-limiting aspect of a wireless telephone is shown and is generally designated 220. As shown, the wireless device 220 includes an on-chip system 222 that includes a digital signal processor 224 and an analog signal processor 226 that are coupled together. As illustrated in FIG. 2, a display controller 228 and a touchscreen controller 230 are coupled to the digital signal processor 224. In turn, a touchscreen display 232 external to the on-chip system 222 is coupled to the display controller 228 and the touchscreen controller 230.

FIG. 2 further indicates that a video encoder 234, e.g., a phase alternating line (PAL) encoder, a sequential couleur a memoire (SECAM) encoder, or a national television system(s) committee (NTSC) encoder, is coupled to the digital signal processor 224. Further, a video amplifier 236 is coupled to the video encoder 234 and the touchscreen display 232. Also, a video port 238 is coupled to the video amplifier 236. As depicted in FIG. 2, a universal serial bus (USB) controller 240 is coupled to the digital signal processor 224. Also, a USB port 242 is coupled to the USB controller 240. A memory 244 and a subscriber identity module (SIM) card 246 may also be coupled to the digital signal processor 224. Further, as shown in FIG. 2, a digital camera 248 may be coupled to the digital signal processor 224. In an exemplary aspect, the digital camera 248 is a charge-coupled device (CCD) camera or a complementary metal-oxide semiconductor (CMOS) camera.

As further illustrated in FIG. 2, a stereo audio CODEC 250 may be coupled to the analog signal processor 226. Moreover, an audio amplifier 252 may coupled to the stereo audio CODEC 250. In an exemplary aspect, a first stereo speaker 254 and a second stereo speaker 256 are coupled to the audio amplifier 252. FIG. 2 shows that a microphone amplifier 258 may be also coupled to the stereo audio CODEC 250. Additionally, a microphone 260 may be coupled to the microphone amplifier 258. In a particular aspect, a frequency modulation (FM) radio tuner 262 may be coupled to the stereo audio CODEC 250. Also, an FM antenna 264 is coupled to the FM radio tuner 262. Further, stereo headphones 266 may be coupled to the stereo audio CODEC 250.

FIG. 2 further indicates that a radio frequency (RF) transceiver 268 may be coupled to the analog signal processor 226. An RF switch 270 may be coupled to the RF transceiver 268 and an RF antenna 272. As shown in FIG. 2, a keypad 274 may be coupled to the analog signal processor 226. Also, a mono headset with a microphone 276 may be coupled to the analog signal processor 226. Further, a vibrator device 278 may be coupled to the analog signal processor 226. FIG. 2 also shows that a power supply 280 may be coupled to the on-chip system 222. In a particular aspect, the power supply 280 is a direct current (C) power supply that provides power to the various components of the wireless device 220 that require power. Further, in a particular aspect, the power supply is a rechargeable DC battery or a DC power supply that is derived from an alternating current (AC) to DC transformer that is connected to an AC power source.

As depicted in FIG. 2, the touchscreen display 232, the video port 238, the USB port 242, the camera 248, the first stereo speaker 254, the second stereo speaker 256, the microphone 260, the FM antenna 264, the stereo headphones 266, the RF switch 270, the RF antenna 272, the keypad 274, the mono headset 276, the vibrator 278, and the power supply 280 are external to the on-chip system 222.

In a particular aspect, one or more of the method steps described herein may be stored in the memory 244 as computer program instructions. These instructions may be executed by a processor 224, 226 in order to perform the methods described herein. Further, the processors, 224, 226, the memory 244, the instructions stored therein, or a combination thereof may serve as a means for performing one or more of the method steps described herein.

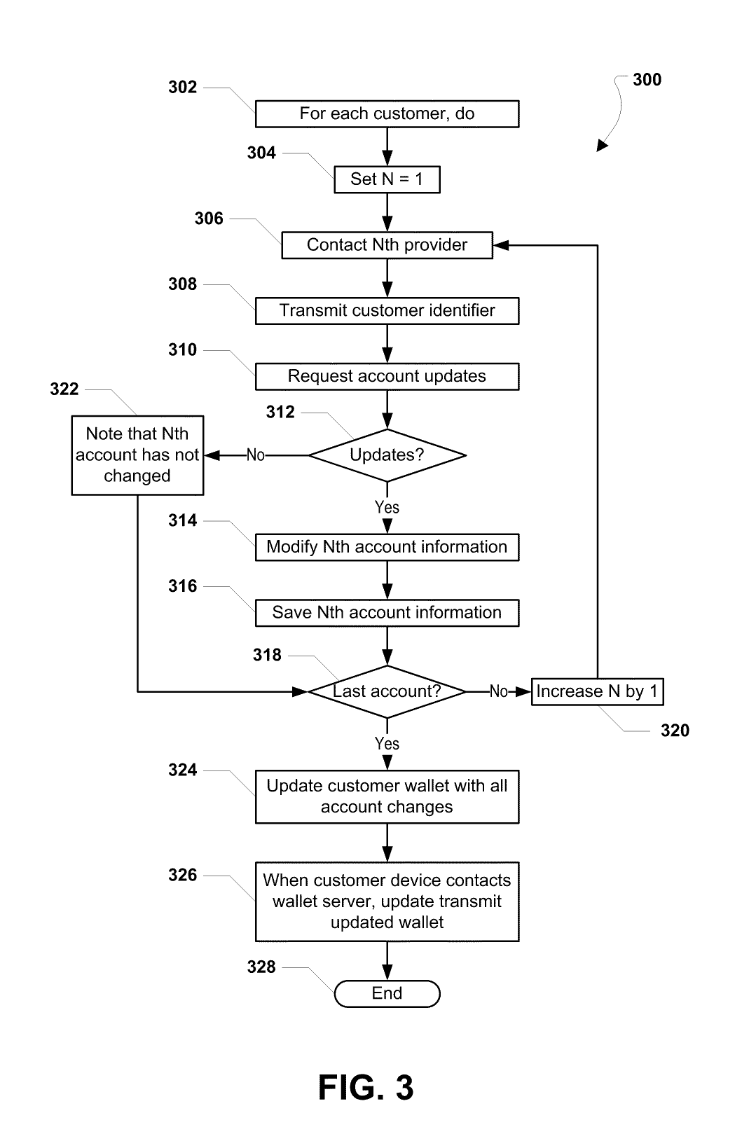

Referring now to FIG. 3, a method of aggregating account information is shown and is generally designated 300. In a particular aspect, the method 300 may be performed by a wallet server, e.g., the wallet server 104 depicted in FIG. 1. As shown, the method 300 begins at block 302 with a do loop wherein for each customer, the following steps may be performed. At block 304, a counter, N, may be set equal to one (1). Moving to block 306, an Nth provider may be contacted. At block 308, a customer identifier may be transmitted to the Nth provider. Further, at block 310, account updates may be requested from the Nth provider.

Proceeding to decision step 312, the wallet server may determine whether an updates have been received from the Nth provider. If so, the method 300 may continue to block 314 and the wallet server may modify the Nth account associated with the Nth provider to reflect the updates received from the Nth provider. Thereafter, the wallet server may save the Nth account information. Continuing to decision step 318, the wallet server may determine if the Nth account is the last account associated with this particular user or customer. If not, the method 300 may proceed to block 320 and the counter, N, may be increase by one (1). Thereafter, the method 300 may return to block 306 and continue as described herein.

Returning to decision step 312, if no updates are received from the Nth provider, the method 300 may move to block 322 and the wallet server may note that the Nth account associated with the Nth provider has not changed. Then, the method 300 may proceed to decision step 318, wherein the wallet server may determine whether the Nth account is the last account. If not, the method 300 may move to block 320 and continue as described herein. If the Nth account is the last account, the method 300 may move to block 324 and the wallet server may update the customer, or user, wallet with all account changes. Thereafter, at block 326, when a customer mobile device contacts the wallet server, the wallet server may transmit the updated wallet to the mobile device. The method 300 may then end at state 328.

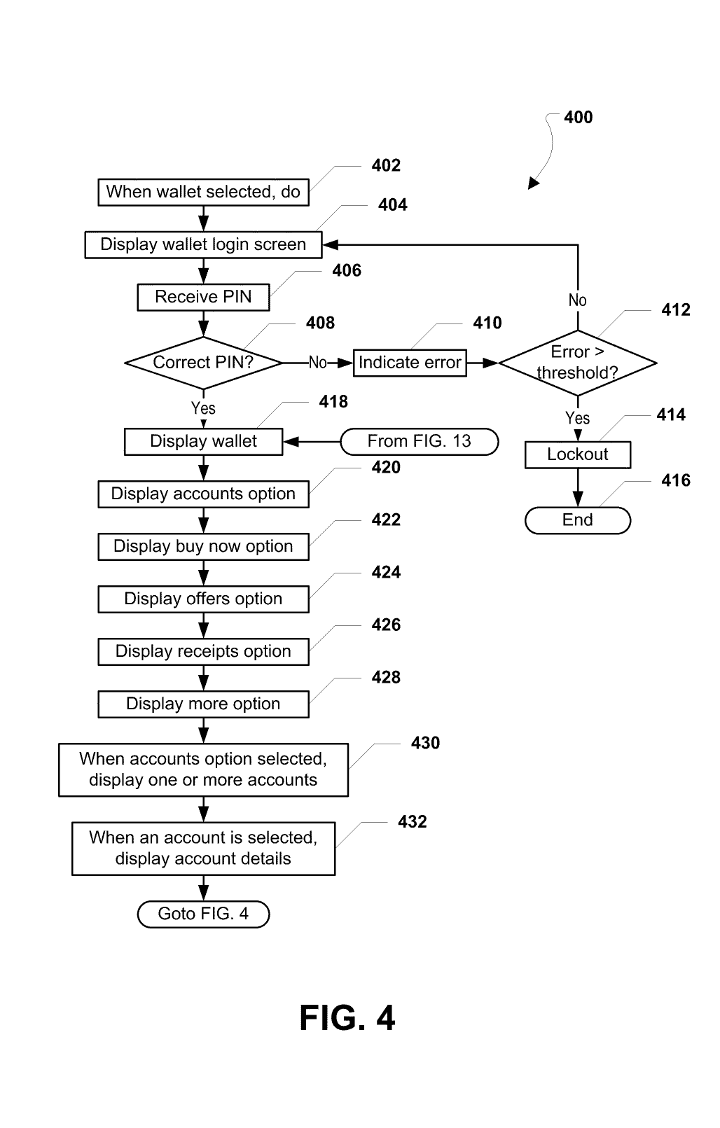

Referring now to FIG. 4 through FIG. 14, a method of providing a mobile wallet at a mobile device is shown and is generally designated 400. In a particular aspect, examples of the various graphical user interface (GUI) elements described in conjunction with the method 400 may be seen in FIG. 15 through FIG. 62. These elements may include one or more of the various GUI features displayed during the execution of the method 400. These features may include GUI screens, GUI soft keys, etc.

Beginning at block 402, when the mobile wallet is selected at the mobile device, the following steps may be performed. At block 404, a wallet login screen may be displayed. The wallet login screen may include a personal identification number (PIN) input field. Further, the wallet login screen may include a numerical key pad, e.g., composed of soft keys numbered from zero to nine. At block 406, PIN may be received. Thereafter, at decision step 408, it may be determined whether the PIN is correct. If not, the method 400 may move to block 410 and an error may be indicated. Next, at decision step 412, it may be determined whether a number of erroneous PIN entries is greater than a threshold. If not, the method 400 may return to block 404 and continue as described herein. If so, the method 400 may proceed to block 414 and a user may be locked out of the mobile wallet. Thereafter, the method 400 may end at state 416.

Returning to decision step 408, if the PIN is correct, the method 400 may move to block 418 and a mobile wallet may be displayed. At block 420, an accounts option may be displayed. At block 422, a buy now option may be displayed. Further, at block 424, an offers option may be displayed. At block 426, a receipts option may be displayed. Additionally, at block 428, a more option may be displayed.

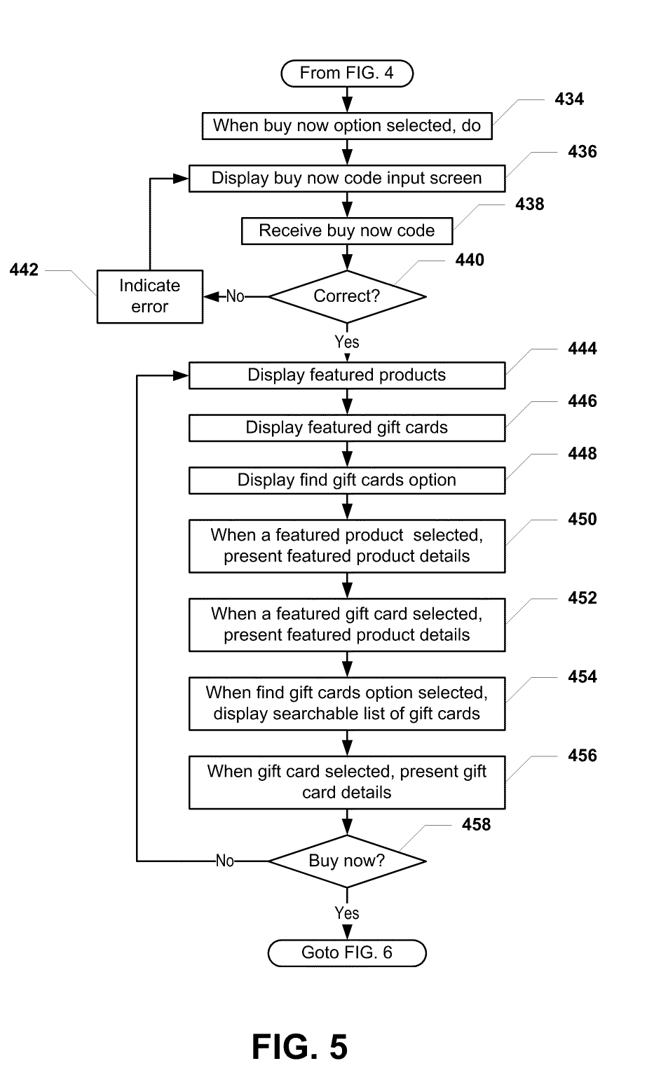

Proceeding to block 430, when the accounts option is selected, one or more user accounts may be displayed. The user accounts may include one or more bank accounts, one or more credit accounts, one or more gift card accounts, one or more rewards accounts, or some other type of account. At block 432, when a particular account is selected, the details about that particular account may be displayed. The account details may include an account balance, a gift card balance, an available credit balance, a rewards balance, an indication of who sent a gift card, a gift card message, etc. Further, the account details may indicate where a gift card may be used and one or more account options, e.g., a transaction history option, an add gift card option, a send a gift card option, a top-up/reload a gift card option, etc. Thereafter, the method 400 moves to block 434 of FIG. 5.

At block 434, when the buy now option is selected, the method 400 may move to block 436. At block 436, a buy now code input screen may be displayed. The buy now code input screen may include a buy now code input field and a QUERTY keyboard comprised of lettered soft keys, a space bar, etc. At block 438, a buy now code may be received. At decision step 438, it may be determined whether the buy now code is correct. If not, the method 400 may continue to block 442 and an error indication may be displayed to the user. Then, the method 400 may return to block 436 and continue as described herein. In a particular aspect, for a second layer of security a lock out feature, similar to that described above, may also be employed for the buy now code.

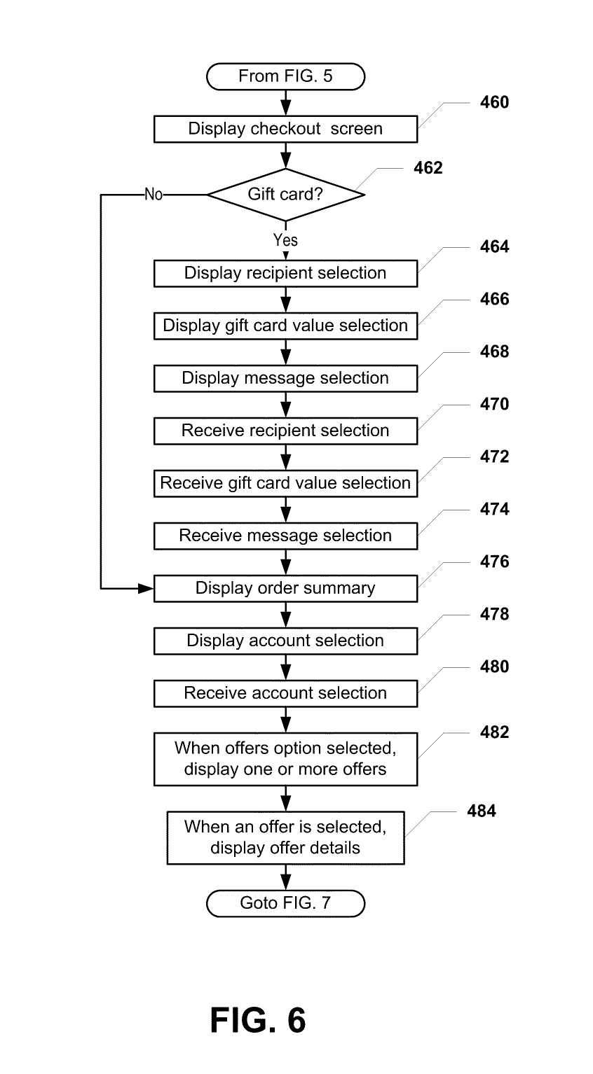

Returning to decision step 440, if the buy now code is correct, the method 400 may continue to block 444 and one or more featured products may be displayed. Featured products may include featured event tickets, featured gift cards, featured ringtones, featured transit tickets, etc. At block 446, one or more featured gift cards may be displayed. Further, at block 448, a find gift cards option may be displayed. For example, gift cards may be found by merchant, by category, by occasion, etc. At block 450, when a featured product is selected, details about the featured product may be displayed. At block 452, when a featured gift card is selected, details about the featured gift card may be displayed. Moreover, at block 454, when the find gift cards option is selected, a searchable list of gift cards may be displayed. Moving to block 456 when a particular gift card is selected, details about the gift card may be displayed. Thereafter, at decision step 458, it may be determined whether buy now is selected. If not, the method 400 may return to block 444 and continue as described herein. Otherwise, if buy now is selected, the method 400 may continue to block 460 of FIG. 6.

At block 460 of FIG. 6, a checkout screen may be displayed. Moreover, at decision step 462, if may be determined if the purchase is a gift card for someone else. If so, the method 400 may continue to block 464 and a recipient selection may be displayed. At block 466, a gift card value selection may be displayed. At block 468, a message selection may be displayed. Further, at block 470 a recipient selection may be received. At block 472, a gift card value selection may be received. Additionally, at block 474, a message selection may be received. Thereafter, the method 400 may proceed to block 476 and continue as described herein.

Returning to decision step 462, if the purchase is not a gift card for someone else, the method 400 may proceed directly to block 476. At block 474, an order summary may be displayed. Next, at block 478 an account selection may be displayed. At block 480, an account selection may be received.

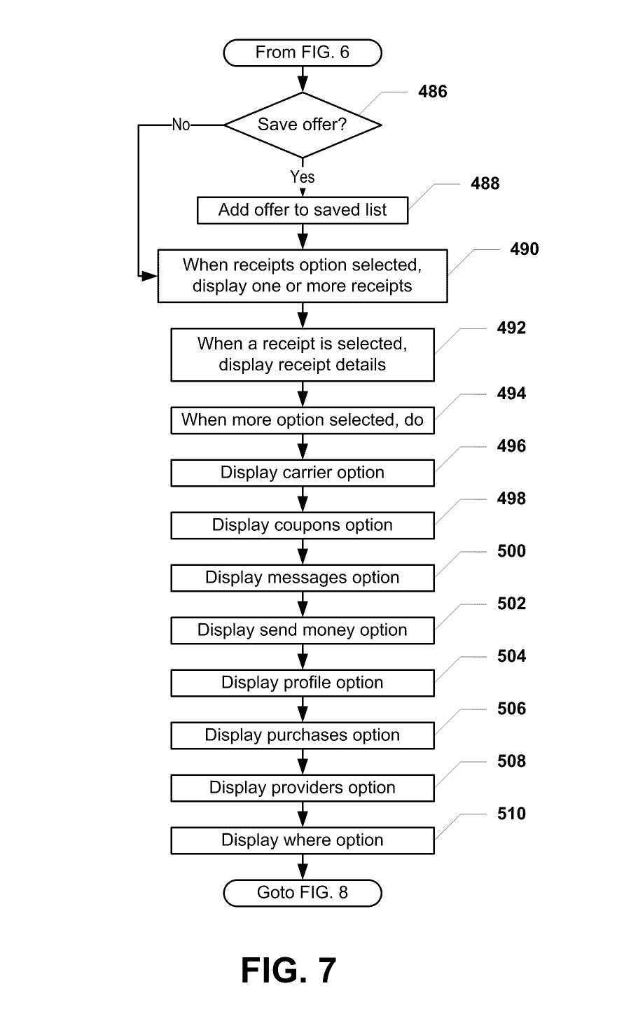

Moving to block 482, when an offers option is selected, one or more offers may be displayed. Further, at block 484, when a particular offer is selected, details concerning the offer may be displayed. Then, the method 400 may continue to block 484 of FIG. 7.

At block 486, it may be determined whether the user wishes to save a particular offer. If so, the method 400 may move to block 488 and the offer may be added to a saved list. At block 490, when the receipts option selected, one or more receipts may be displayed. Further, at block 492, when a particular receipt is selected, receipt details may be displayed.

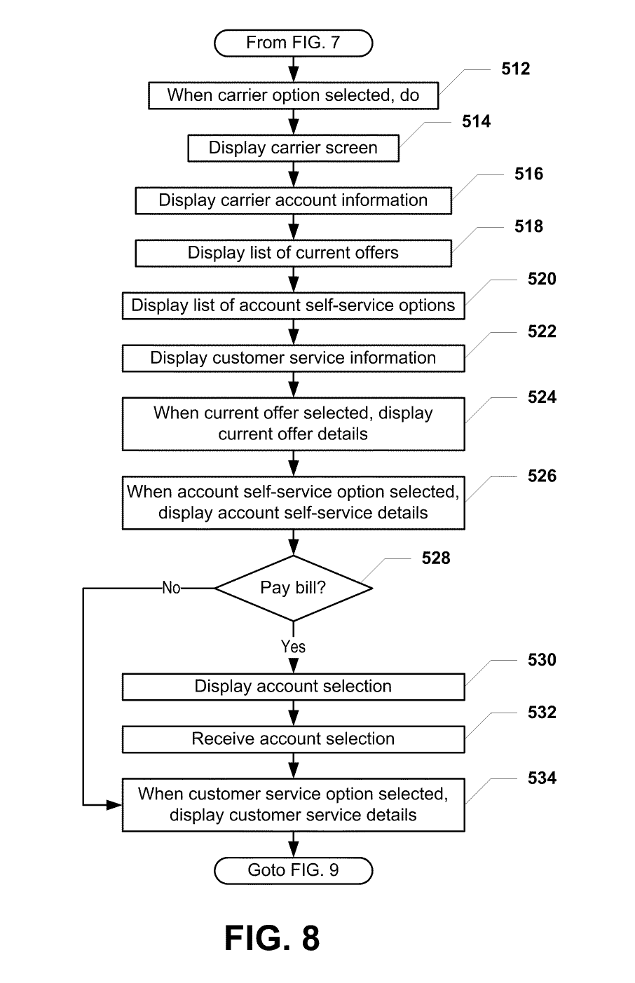

At block 494, when the more option is selected, the following steps may be performed. At block 496, a carrier option may be displayed. At block 498, a coupons option may be displayed. Moreover, at block 500, a messages option may be displayed. At block 502, a send money option may be displayed. At block 504, a profile option may be displayed. Further, at block 506, a purchases option may be displayed. Also, at block 508, a providers option may be displayed. At block 510, a where option may be displayed. Thereafter, the method 400 may continue to block 512 of FIG. 8.

At block 512 of FIG. 8, when the carrier option selected, the following steps may be performed. At block 514, a carrier screen may be displayed. At block 516, carrier account information may be displayed. Further, at block 518, a list of current offers may be displayed. Also, at block 520, a list of account self-service options may be displayed. At block 522, customer service information may be displayed. At block 524, when a current offer is selected, current offer details may be displayed. Moving to block 526, when the account self-service option selected, account self-service details may be displayed. These details may include a view accounts option, a pay bill option, a buy gift card option, a plans and service option, a settings option, etc.

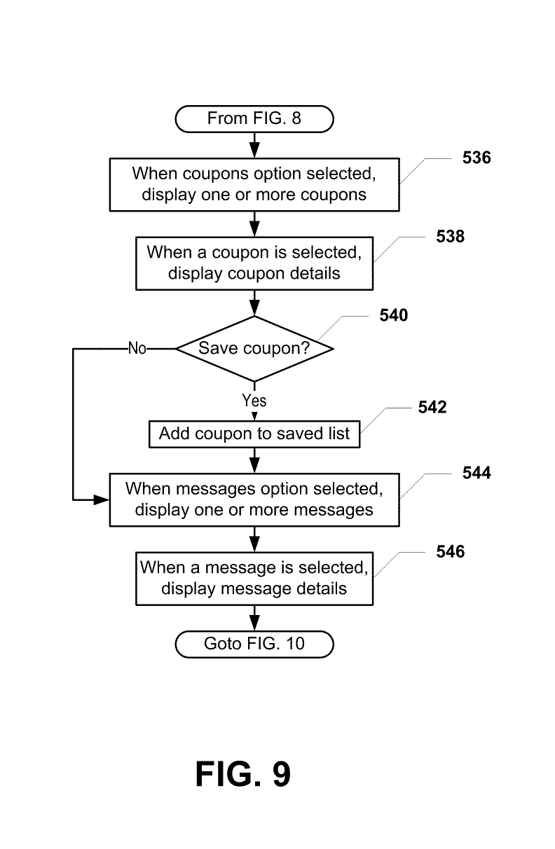

At decision step 528, it may be determined whether the user wants to pay a bill. If so, the method 400 may proceed to block 530 and an account selection may be displayed. At block 532, an account selection may be received. Further, at block 534, when the customer service option selected, customer service details may be displayed. The customer service details may include a call customer service option, a map/directions option, a website option, etc. From block 534, the method 400 may continue to block 536 of FIG. 9.

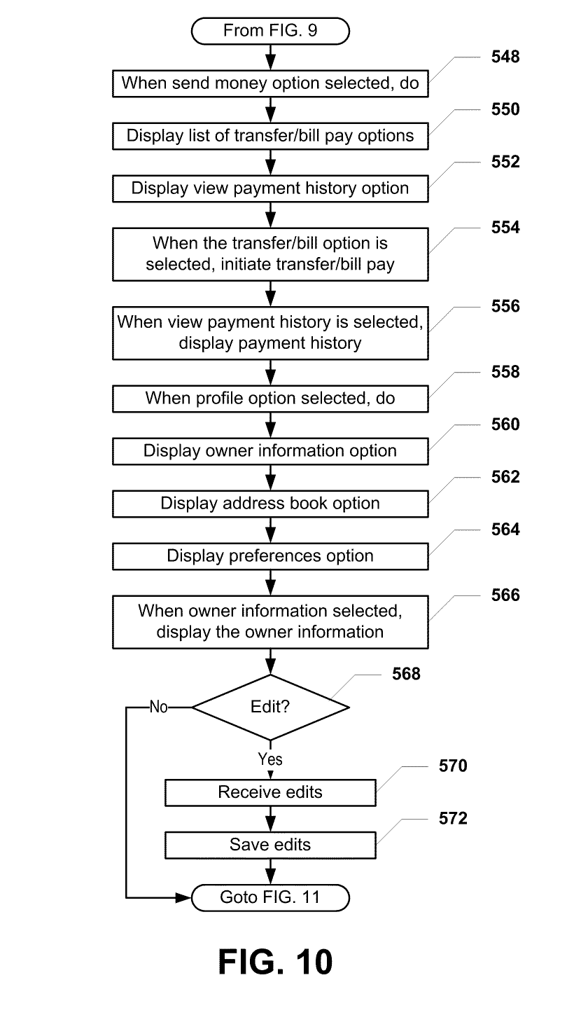

At block 536, when a coupons option selected, one or more coupons may be displayed. Moving to block 538, when a coupon is selected, coupon details may be displayed. At decision step 540, it may be determined whether the user wants to save a particular coupon. If so, the method 400 may move to block 542, and the coupon may be added to a saved coupons list. Thereafter, at block 544, when the messages option selected, one or more messages may be displayed. Further, at block 546, when a particular message is selected, message details may be displayed. The method 400 may then continue to block 548 of FIG. 10.

At block 548, when the send money option selected, the following steps may be performed. At block 550, a list of transfer/bill pay options may be displayed. At block 552, a view payment history option may be displayed. Further, at block 554, when the transfer/bill option is selected, transfer/bill pay may be initiated. Moving to block 556, when the view payment history is selected, a payment history may be displayed.

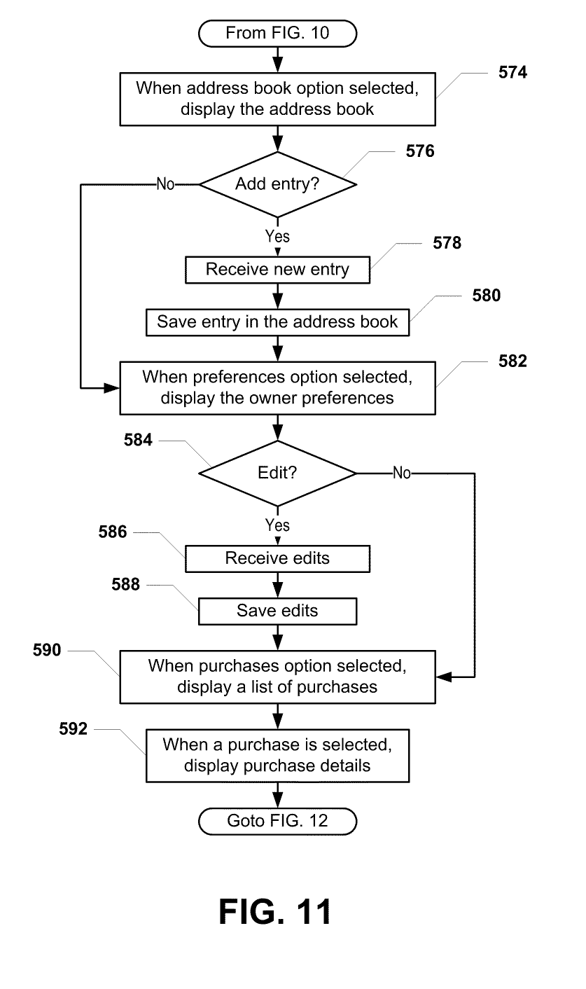

Next, at block 558, when the profile option is selected, the following steps may be performed. At block 560, an owner information option may be displayed. At block 562, an address book option may be displayed. Also, at block 564, a preferences option may be displayed. Moving to block 566, when the owner information option is selected, the owner information may be displayed. At decision step 568, it may be determined whether the user wishes to edit the owner information. If so, the method 400 may move to block 570 and one or more edits may be received. Thereafter, the method 400 may move to block 572 and the edits may be saved. From block 572, the method 400 may continue to block 574 of FIG. 11. Also, returning to decision step 568, if the user does not want to edit the owner information, the method 400 may proceed directly to block 574 of FIG. 11.

At block 574, when the address book option selected, the address book may be displayed. Continuing to decision step 576, it may be determined whether the user would like to add a new entry. If so, the method 400 may move to block 578 and a new entry may be received. At block 580, the entry may be saved in the address book. Thereafter, the method 400 may move to block 582. Returning to decision step 576, if the user does not want to add a new entry, the method 400 may move directly to block 582.

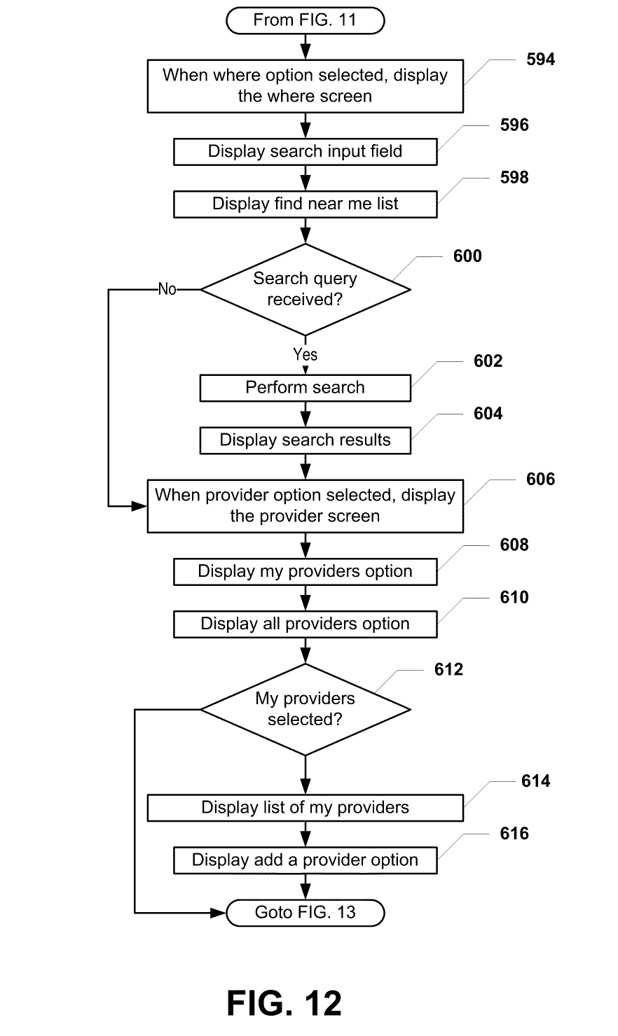

At block 582, when the preferences option is selected, one or more the owner preferences may be displayed. At decision step 584, it may be determined whether to edit the one or more owner preferences. If so, one or more edits may be received at block 586. Then, at block 588, the edits may be saved. At block 590, when the purchases option is selected, a list of purchases may be displayed. Moreover, at block 592, when a particular purchase is selected, purchase details for the particular purchase may be displayed. The method 400 may then continue to block 594 of FIG. 12.

At block 594, when the where option is selected, the where screen may be displayed. At block 596, a search input field may be displayed. Further, at block 598, a find near me list may be displayed. Moving to decision step 600, it may be determined whether a search query is received. If so, the method 400 may proceed to block 602 and a search may be performed. At block 604, the search results may be displayed. Thereafter, the method 400 may move to block 606. Returning to decision step 600, if a search query is not received, the method 400 may move directly to block 606.

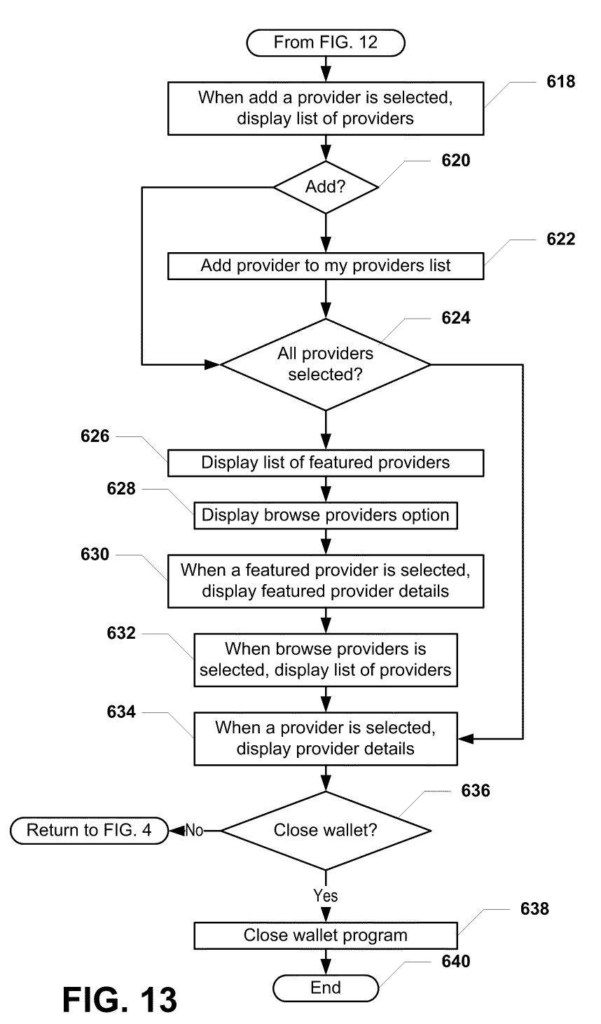

At block 606, when the provider option selected, the provider screen may be displayed. At block 608, a my providers option may be displayed. Also, at block 610, an all providers option may be displayed. Continuing to decision step 612, it may be determined whether the my providers option is selected. If so, a list of my providers may be displayed at block 614. In a particular aspect, the my providers may include a list of the providers that the user has saved in his or her mobile wallet. Next, at block 616, an add a provider option may be displayed. Then, the method 400 may continue to block 618 of FIG. 13. Returning to decision step 612, if my providers is not selected, the method 400 may proceed directly to block 618 of FIG. 13.

At block 618, when the add a provider option is selected, a list of providers may be displayed. At decision step 620, it may be determined whether the user wishes to add a provider. If so, the method 400 may move to block 622 and the provider may be added to the my providers list. Thereafter, the method 400 may move to decision step 624. Returning to decision step 620, if the user does not want to add a provider, the method 400 may move directly to decision step 624.

At decision step 624, it may be determined whether the all providers option is selected. If so, a list of featured providers may be displayed at block 626. At block 628, a browse providers option may be displayed. Further, at block 630, when a featured provider is selected, featured provider details may be displayed. At block 632, when browse providers is selected, a list of providers may be displayed. Thereafter, at block 634, when a provider is selected, provider details may be displayed. The method 400 may then move to decision step 636. Returning to decision step 624, if the all providers option is not selected, the method 400 may move directly to decision step 636.

At decision step 636, it may be determined whether the mobile wallet is closed. If so, the mobile wallet may be closed at block 638. Thereafter, the method 400 may end at state 640. Otherwise, the method 400 may return to block 418 of FIG. 4 and continue as described herein.

It is to be understood that the method steps described herein do not necessarily have to be performed in the order as described. Further, words such as “thereafter”, “then”, “next”, etc. are not intended to limit the order of the steps. These words are simply used to guide the reader through the description of the method steps.

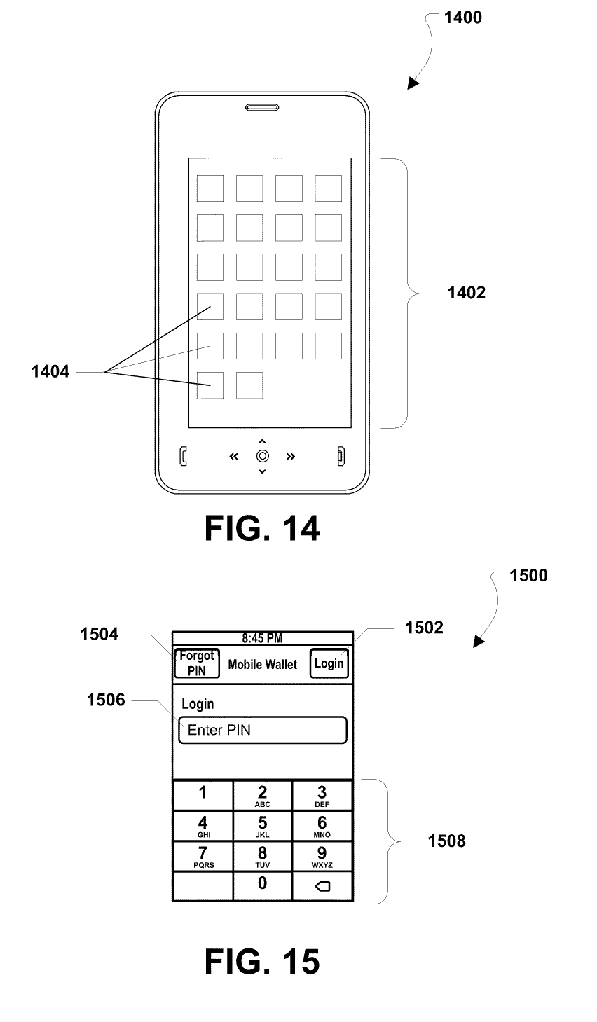

Referring now to FIG. 14, an exemplary mobile device is shown and is generally designated 1400. As shown, the mobile device may include a display 1402 in which a menu of program icons 1404 may be displayed. Further, the mobile device may include a close button 1406 that may be used to close a program and return to the menu of program icons 1404.

FIG. 15 illustrates a mobile wallet login screen, designated 1500, that may be accessed from the menu of program icons 1404 (FIG. 14). The mobile wallet login screen 1500 may include a login button 1502 and a forgot PIN button 1504. Further, the mobile wallet login screen 1500 may include a PIN entry input field 1506 and a numerical keypad 1508. In a particular aspect, the login button 1502, the forgot PIN button 1504, and the numerical keypad 1508 may be comprised of soft keys. Further, in a particular aspect, the remaining buttons described herein in conjunction with the mobile wallet may be soft keys.

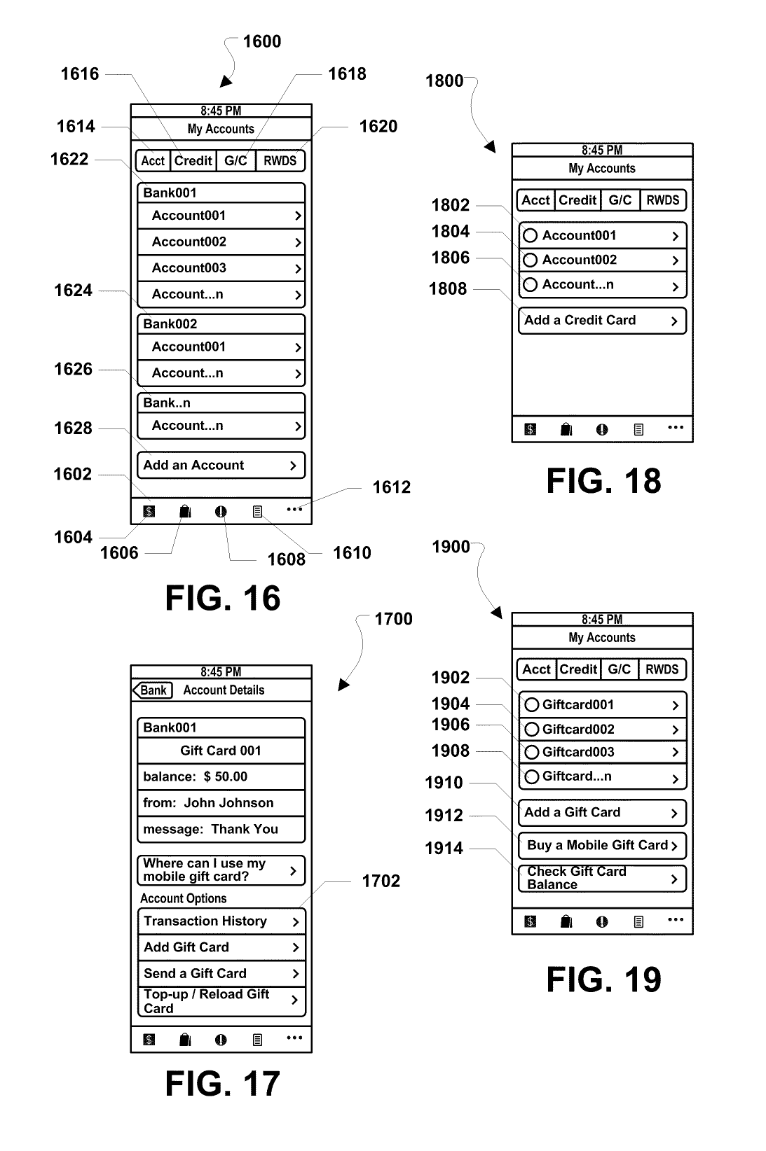

FIG. 16 illustrates a my accounts screen, designated 1600. The my accounts screen 1600 may include a main button menu 1602 that may include a first accounts button 1604, a buy now button 1606, an offers button 1608, a receipts button 1610, a more button 1612, or a combination thereof. The buttons 1604, 1606, 1608, 1610, 1612 may be displayed at one or more of the additional GUI screens described herein and may allow a user to jump directly from a particular screen to a screen associated with one of these buttons 1604, 1606, 1608, 1610, 1612. Further, the my accounts screen 1600 may include a second accounts button 1614, a credit button 1616, a gift cards button 1618, a rewards button 1620, or a combination thereof.

In a particular aspect, when the second accounts button 1614 is selected, a first account information window 1622, a second account information window 1624, and an Nth account information window 1626 may be displayed. The my accounts screen 1600 may also include an add an account button 1628.

When any of the accounts displayed are selected, an account details screen 1700, shown in FIG. 17, may be displayed. The account details screen 1700 may include details such as a gift card balance, who a gift card came from, a message, etc. Further, the account details screen may include one or more account options 1702, e.g., a transaction history option, an add gift card option, a send a gift card option, a top-up/reload gift card option, or a combination thereof. The top-up/reload gift card option may allow a user to add value to a gift card that he or she owns or to add value to a gift card belonging to someone else.

FIG. 18 illustrates a credit accounts screen 1800 that includes a first credit account 1802, a second credit account 1804, and an Nth credit account 1806. Further, the credit accounts screen 1800 may include an add a credit card option 1808 that a user may select in order to add a credit card to his or her mobile wallet. When any of the credit accounts 1802, 1804, 1806 are selected, details concerning that particular account may be displayed.

FIG. 19 illustrates a gift card accounts screen 1900 that includes a first gift card account 1902, a second gift card account 1904, a third gift card account 1906, and an Nth gift card account 1908. Further, the gift card accounts screen 1900 may include an add a gift card option 1910 that a user may select in order to add a gift card to his or her mobile wallet. When any of the gift card accounts 1902, 1904, 1906, 1908 are selected, details concerning that particular gift card account may be displayed. The gift card accounts screen 1900 may also include a buy a mobile gift card option 1912 and a check gift card balance option 1914.

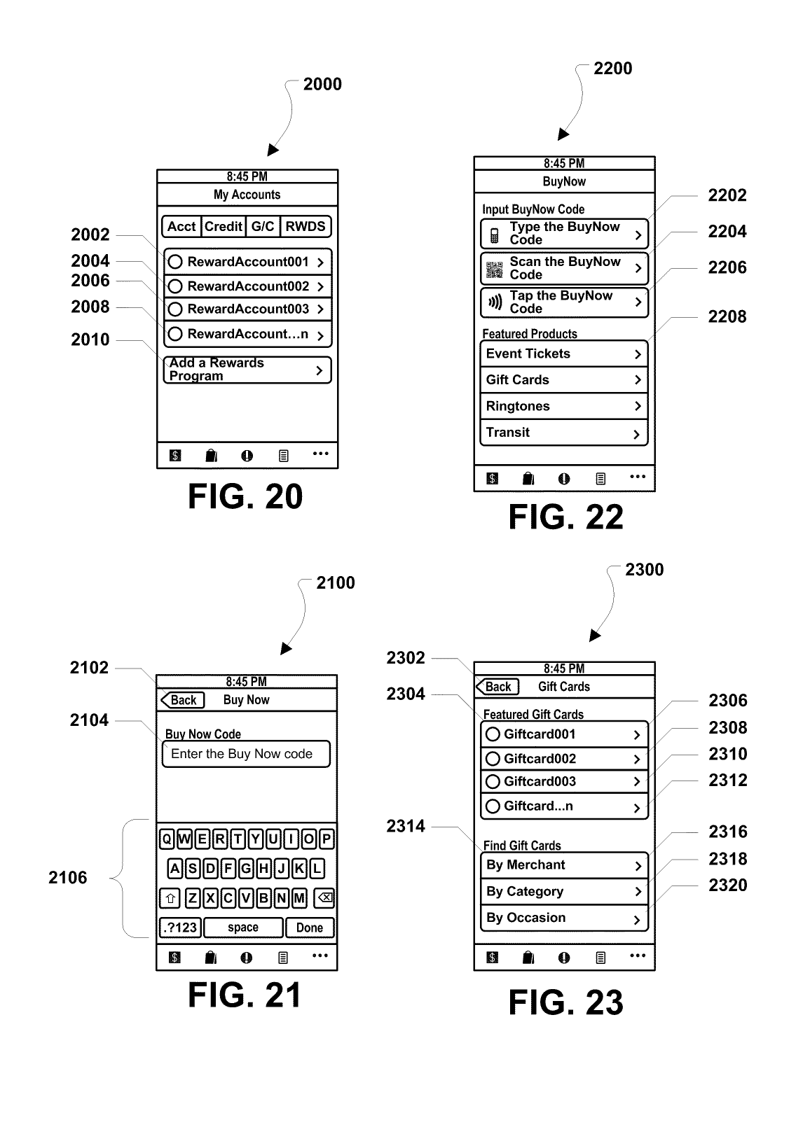

FIG. 20 illustrates a reward accounts screen 2000 that includes a first reward account 2002, a second reward account 2004, a third reward account 2006, and an Nth reward account 2008. Further, the reward accounts screen 2000 may include an add a rewards program option 2010 that a user may select in order to add a reward to his or her mobile wallet. When any of the reward accounts 2002, 2004, 2006, 2008 are selected, details concerning that particular reward account may be displayed.

FIG. 21 depicts a buy now input screen 2100. The buy now input screen includes a back button 2102, a buy now code input field 2104, and a QWERTY keyboard 2106. Using the buy now screen 2100, a user may enter his or her buy now code. Once a correct buy now code is input, the user may relatively easily shop at mobile stores without having to enter user preferences, e.g., payment methods, payment accounts, shipping, address, etc. The user may simply press a buy now button and that information may automatically be transmitted to a merchant via a mobile store.

FIG. 22 illustrates a buy now screen 2200. The buy now screen 2200 may include a type the buy now code option 2202, a scan the buy now code option 2204, a tap the buy now code option 2206, or a combination thereof. Further, the buy now screen 2200 may include a featured products menu 2208 may include event tickets, gift cards, ringtones, transit tickets, or a combination thereof. In a particular aspect, the buy now screen 2200 may be accessed by a selecting the buy now button 1606 from the main menu 1602.

Referring to FIG. 23, a gift cards screen 2300 is shown. The gift cards screen 2300 may include a back button 2302 and a featured gift card window 2304. The featured gift card window 2304 may include a first gift card 2306, a second gift card 2308, a third gift card 2310, and an Nth gift card 2312. The gift cards screen 2300 may also include a find gift cards window 2314. The find gift cards window 2314 may include a find by merchant option 2316, a find by category option 2318, a find by occasion option 2320, or a combination thereof.

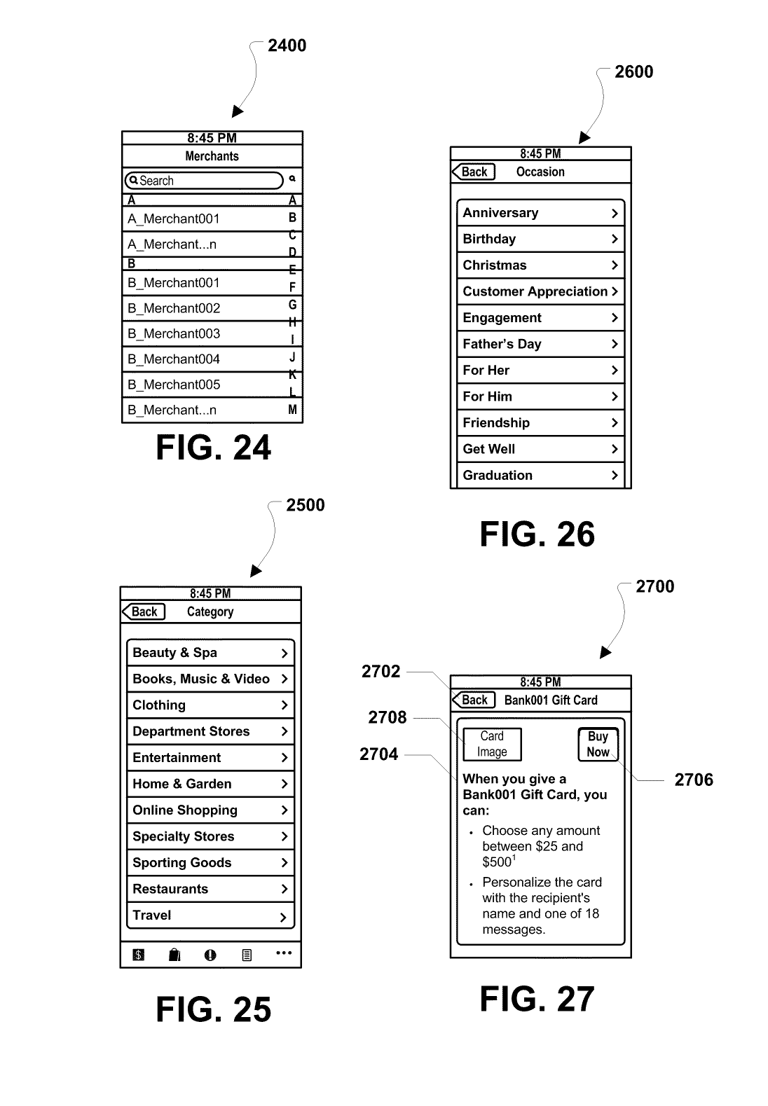

When the find by merchant option 2316 is selected, a merchants screen 2400, shown in FIG. 24, may be displayed. In a particular aspect, the merchants may be listed alphabetically. When the find by category option 2318 is selected, a category screen 2500, shown in FIG. 25, may be displayed. The categories may be listed alphabetically. When the find by occasion option 2320 is selected, an occasion screen 2600, shown in FIG. 26, may be displayed. In a particular aspect, the occasions may be listed alphabetically.

Referring to FIG. 27, a detailed gift card screen is shown and is generally designated 2700. As shown, the detailed gift card screen may include a back button 2702, a details window 2704, a buy now button 2706, and a card image 2708.

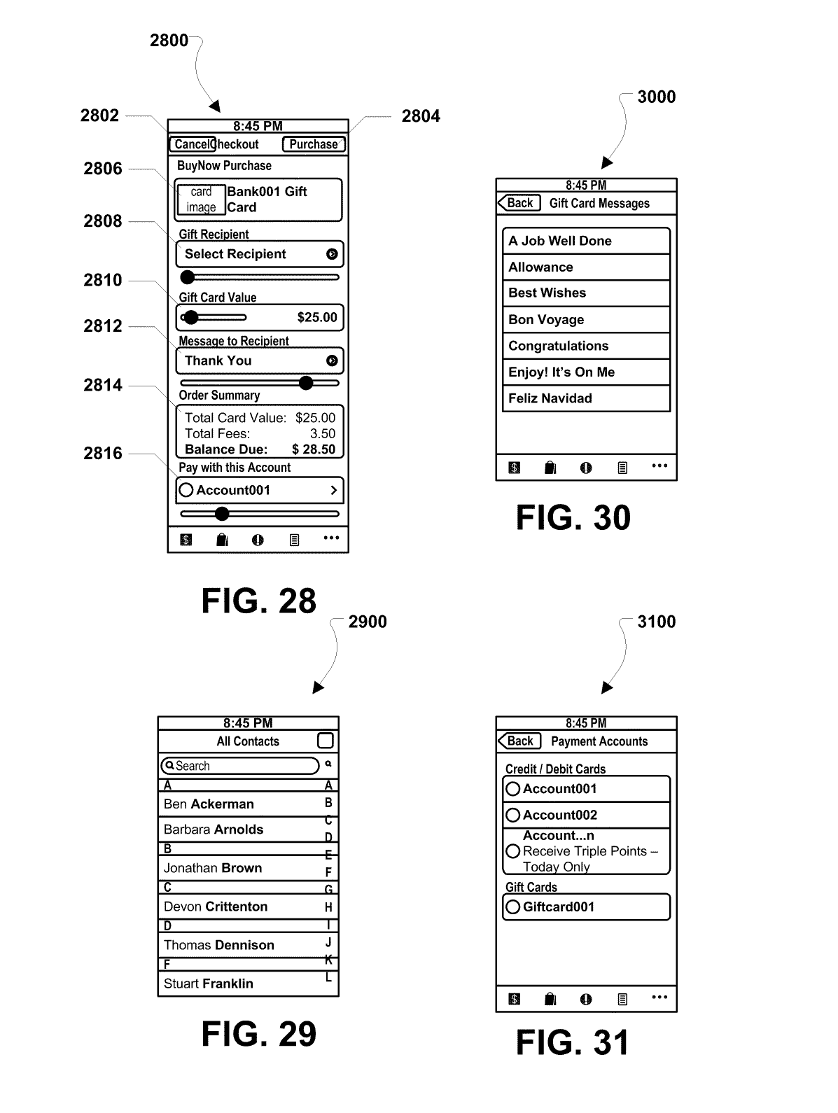

FIG. 28 illustrates a checkout screen 2800. As shown, the checkout screen 2800 may include a cancel button 2802 and a purchase button 2804. Further, the checkout screen 2800 may include a buy now purchase window 2806 that shows what is being purchased. Also, the checkout screen 2800 may include a select recipient option 2808. The select recipient option 2808 may be a slider or may be a button that leads to an all contacts screen 2900, show in FIG. 29. The checkout screen 2800 may further include a gift card value option 2810 that may include a slider that may be manipulated in order to select a value of a gift card. Further, the checkout screen 2800 may include a message option 2812 that may include a slider that a user may slide back and forth in order to select a message to add to a gift card. Alternatively, the message option 2812 may include a button that leads to a gift card messages screen 3000, shown in FIG. 30, that may include a list of messages through which the user may scroll in order to select a particular message. As shown in FIG. 28, the checkout screen 2800 may also include an order summary window 2814 that may include a total card value indicator, a total fees indicator, a balance due indicator, or a combination thereof. The checkout screen 2800 may also include a pay with this account option 2816 which may include a slider that a user may use to select an account to pay for the gift card. The pay with this account option 2816 may also be selected in order to provide a payment accounts screen 3100, shown in FIG. 31, that may include a list of accounts that the user may use to purchase the gift card. The payment accounts screen 3100 shows that an account may include an incentive to use that particular account. For example, the Nth account includes the “push” or incentive that the user may “Receive Triple Points—Today Only” for using the account to pay.

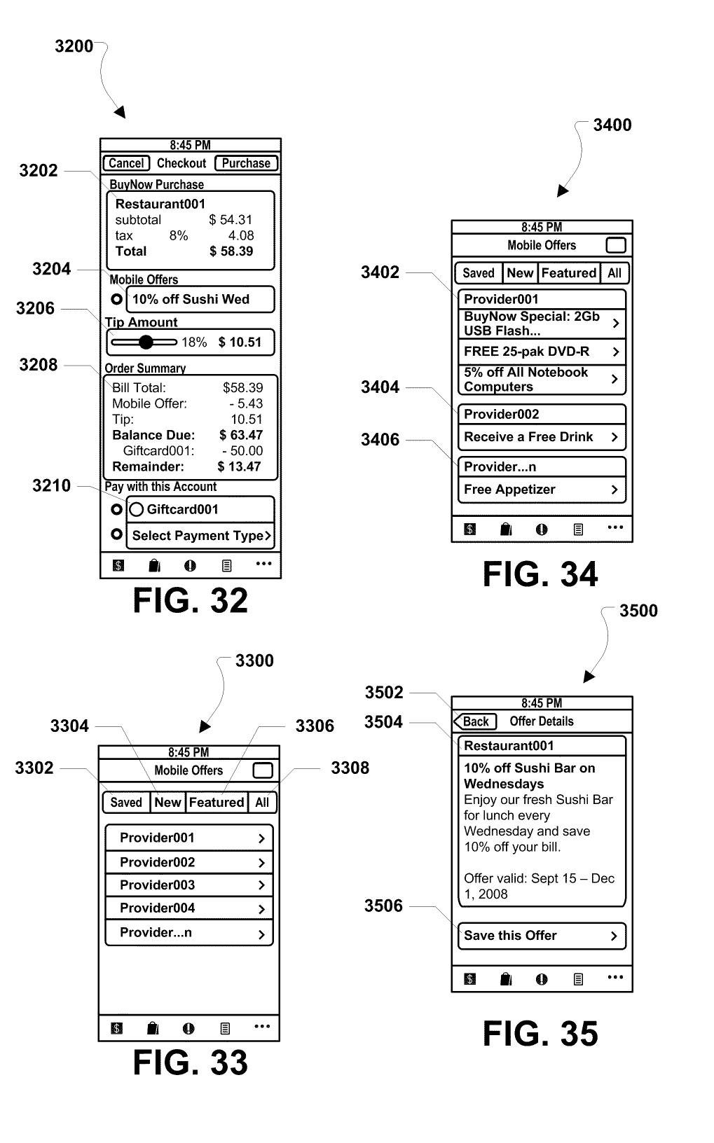

Referring now to FIG. 32, an alternative embodiment of a checkout screen is shown and is generally designated 3200. In a particular aspect, the checkout screen 3200 may be associated with a mobile purchase at a restaurant. As shown, the checkout screen 3200 may include a buy now purchase window 3202, a mobile offers window 3204, a tip amount option 3206, an order summary window 3208, and a pay with this account window 3210. The buy now purchase window 3202 may include details concerning the purchase. The mobile offers window 3204 may include one or more offers specific to the current purchase. Further, the tip amount option 3206 may include a tip amount slider that a user may use to select a tip to apply to the current purchase. The order summary window 3208 may include details concerning the current purchase, e.g., a bill total indicator, a mobile offer discount indicator, a tip amount indicator, a balance due indicator, a gift card amount indicator, a remaining balance indicator, or a combination thereof. The pay with this account window 3210 may allow a user to select a method of payment, e.g., a gift card, etc. The checkout screen 3200 may also include a cancel button 3212 and a purchase button 3214.

FIG. 33 depicts a mobile offers screen 3300 that may be accessed by selecting the mobile offers button 1608 from the main menu 1602. The mobile offers screen 3300 may include a saved offers button 3302, a new offers button 3304, a featured offers button 3306, an all offers button 3308, or a combination thereof. Further, the mobile offers screen 3300 may include a providers window 3310 that may display a list of providers associated with each type of offer, i.e., saved, new, featured, and all.

FIG. 34 illustrates a featured mobile offers screen 3400 that may be accessed by selecting the featured offers button 3306 at the mobile offers screen 3300 (FIG. 33). As shown, the featured mobile offers screen 3400 may include a first provider window 3402, a second provider window 3404, and an Nth provider window 3406. Each provider window 3402, 3404, 3406 may list offers associated with each particular provider. When a particular offer is selected, an offer details screen 3500, shown in FIG. 35, may be displayed. The offer details screen 3500 may include a back button 3502, a details window 3504, and a save this offer option 3506. The details window 3504 may include details concerning the offer and the save this offer option 3506 may be selected in order to add this offer to a saved offers list.

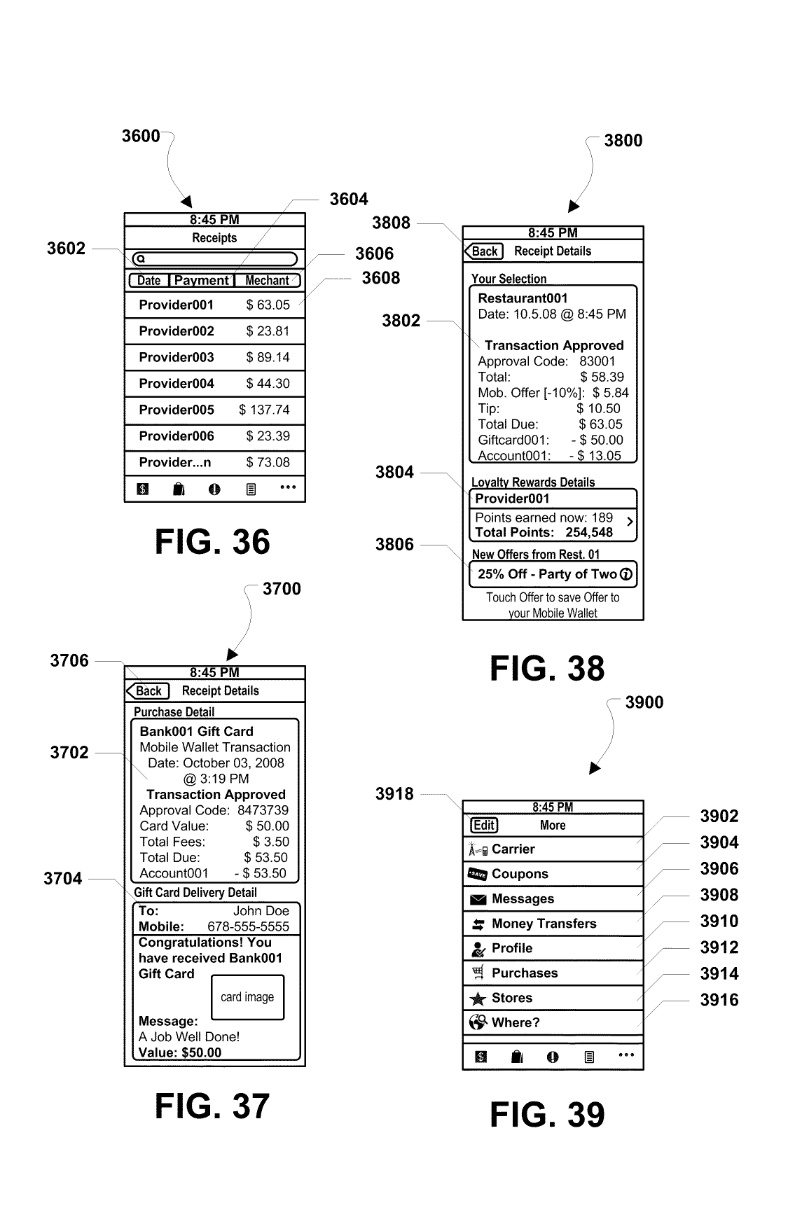

Referring now to FIG. 36, a receipts screen, designated 3600, is shown. The receipts screen 3600 may include a date button 3602, a payment button 3604, a merchant button 3606, or a combination thereof. The date button 3602 may be used to access the receipts by the date of purchase. The payment button 3604 may be used to access the receipts by the method of purchase. The merchant button 3606 may be used to list the receipts by particular merchants. The receipts screen 3600 may also include a provider window 3608 that may display the receipts for various providers, e.g., provider 1 through provider N.

Selecting any receipt from the receipts screen 3600 may allow the user to view the receipt details screen 3700, shown in FIG. 37. The receipts details screen 3700 may include a purchase details window 3702 and a gift card delivery detail window 3704. The purchase details window 3702 may display the details of a particular purchase, e.g., date, approval code, card value, total fees, total amount due, account used, or a combination thereof. The gift card delivery details window 3704 may display the details of a particular gift card purchase, e.g., to, mobile number, message, card image, value, or a combination thereof. As shown, the receipt details screen 3700 may also include a back button 3706 that a user may use to navigate back to the receipts screen 3600 (FIG. 36).

Referring now to FIG. 38, an alternative receipt details screen 3800 is shown. In a particular aspect, the receipt details screen 3800 may be associated with a restaurant purchase. The receipt details screen 3800 may include a selection window 3802, a loyalty rewards window 3804, a new offers window 3806, or a combination thereof. The selection window 3802 may include details concerning the current purchase, e.g., a restaurant name, a date, an approval code, a total, a mobile offer indicator, a tip indicator, a total amount due indicator, a gift card amount indicator, a purchase account indicator, or a combination thereof. The loyalty rewords details window 3804 may display a points earned indicator and a total points indicator. The new offers window 3806 may display new offers from the current restaurant. A user may touch a particular offer in order to save the particular offer to the mobile wallet. As shown, the receipt details screen 3800 may also include a back button 3808 that a user may use to navigate back to the receipts screen 3600 (FIG. 36).

FIG. 39 illustrates a more screen, generally designated 3900, that may be accessed by selecting the more button 1612 from the main menu (FIG. 16). The more screen 3900 may include a carrier option 3902, a coupons option 3904, a messages option 3906, a send money option 3908, a profile option 3910, a purchases option 3912, a providers option 3914, a where option 3916, or a combination thereof. Further, the more screen 3900 may include an edit button 3918 that may be selected to allow the user to edit the more screen 3900.

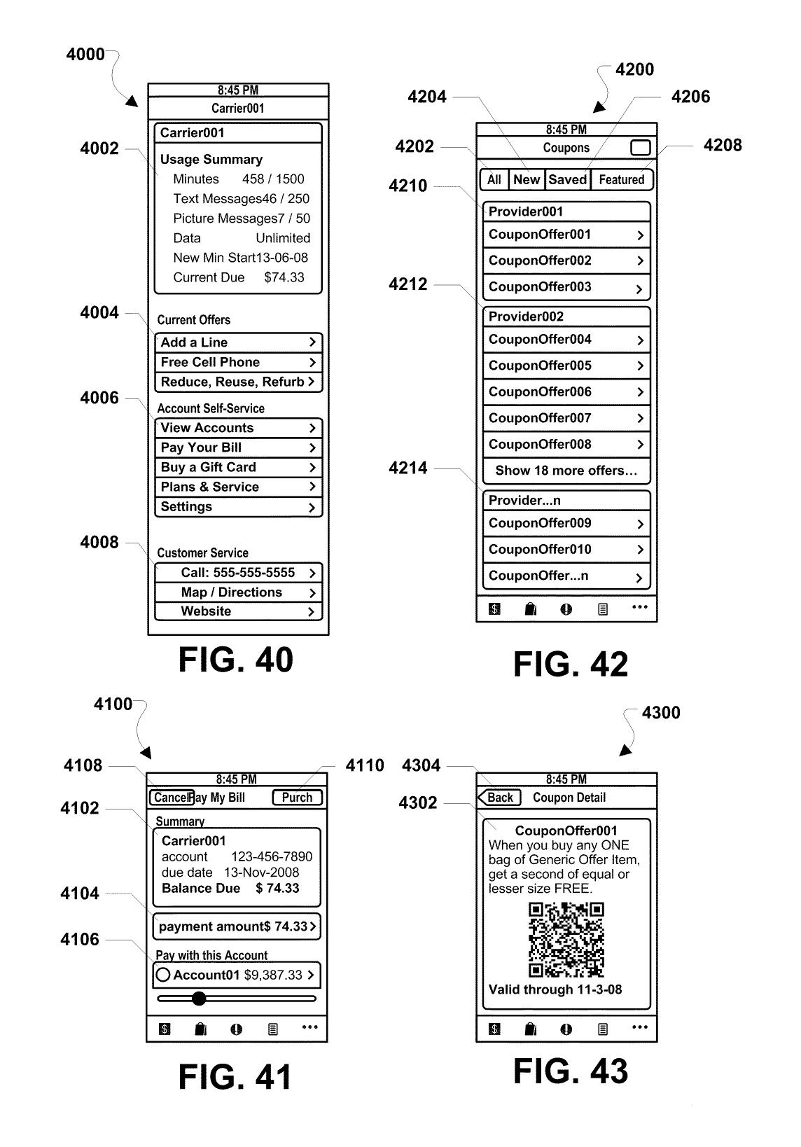

FIG. 40 depicts a carrier screen 4000 that may be accessed by selecting the carrier option 3902 (FIG. 39) from the more screen 3900 (FIG. 39). The carrier screen 4000 may include a carrier window 4002, a current offers window 4004, an account self-service window 4006, a customer service window 4008, or a combination thereof. The carrier window 4002 may include details concerning the user's account, e.g., an account number and a usage summary. The usage summary may include minutes used, text messages sent, picture messages sent, data usage, a new minutes start date, a current amount due, or a combination thereof. The current offers window 4004 may include an add a line option; a free cell phone offer; a reduce, reuse, refurb option; or a combination thereof. The account self-service window 4006 may include a view accounts option, a pay your bill option, a buy a gift card option, a plans and service option, a settings option, or a combination thereof. The customer service window 4008 may include a call customer service option, a map/directions option, a website option, or a combination thereof.

Referring to FIG. 41, a pay my bill screen 4100 is illustrated. The pay my bill screen 4100 may include a summary window 4102, a payment amount indicator 4104, a pay with this account option 4106, or a combination thereof. The summary window 4102 may include a carrier name, an account number, a due date, a balance due, or a combination thereof. The payment amount indicator 4104 may indicate a current payment due. The pay with this account option 4106 may include a slider that a user may operate in order to select an account from which payment may be made. The pay my bill screen 4100 may also include a cancel button 4108 and a purchase button 4110.

FIG. 42 shows a coupons screen, generally designated 4200. The coupons screen 4200 may be accessed by selecting the coupons option 3904 (FIG. 39) at the more screen 3900 (FIG. 39). The coupons screen 4200 may include an all button 4202, a new button 4204, a saved button 4204, a featured button 4206, or a combination thereof. The coupons screen 4200 may further include a first provider window 4210, a second provider window 4212, and an Nth provider window 4214. Each provider window 4210, 4212, 4214 may include details concerning coupons offered by each provider.

When a particular coupon is selected, a coupon detail screen 4300, shown in FIG. 43, may be displayed. The coupon detail screen 4300 may include a coupon detail window 4302 and a back button 4304. The coupon detail window 4302 may include details about the particular coupon, a valid through date, a coupon bar code, or a combination thereof. The back button 4304 may be used to navigate back to the coupons screen 4200 (FIG. 42).

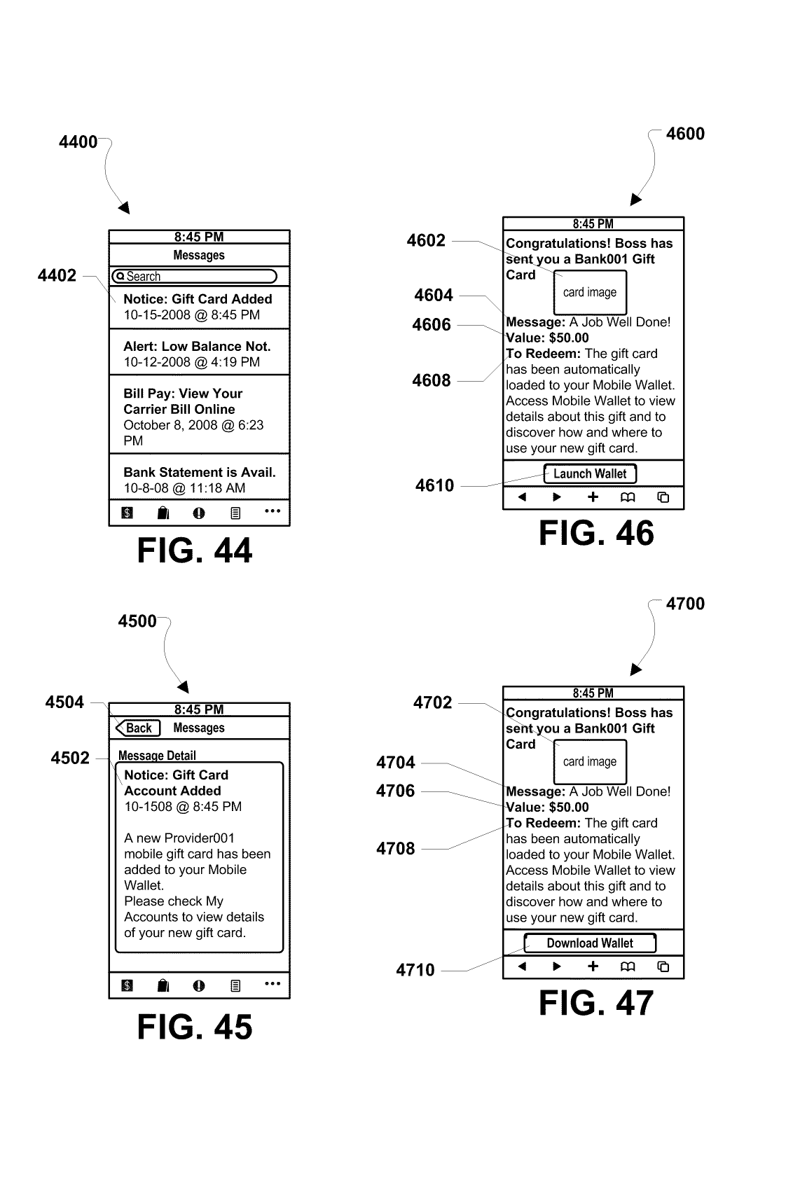

Referring now to FIG. 44, a messages screen is shown and is generally designated 4400. The messages screen 4400 may be accessed by selecting the messages option 3906 (FIG. 39) at the more screen 3900 (FIG. 39). As shown, the messages screen 4400 includes a message list 4402. When a particular message is selected, a message detail screen 4500, shown in FIG. 45, may be displayed. The message detail screen 4500 may include a message details window 4502 and a back button 4504. The message details window 4502 may include details about the selected message. The back button 4504 may be used to navigate back to the messages screen 4400.

FIG. 46 illustrates a first aspect of a gift card message, designated 4600. The gift card message 4600 may include a gift card image 4602, a message 4604, a value indicator 4606, an instruction to redeem 4608, or a combination thereof. Further, the gift card message 4600 may include a launch wallet button 4610 that may be selected in order to launch the mobile wallet on the user mobile device.

FIG. 47 depicts a second aspect of a gift card message, designated 4700. The gift card message 4700 may include a gift card image 4702, a message 4704, a value indicator 4706, an instruction to redeem 4708, or a combination thereof. Further, the gift card message 4700 may include a download wallet button 4710 that may be selected in order to download the mobile wallet application to the user mobile device.

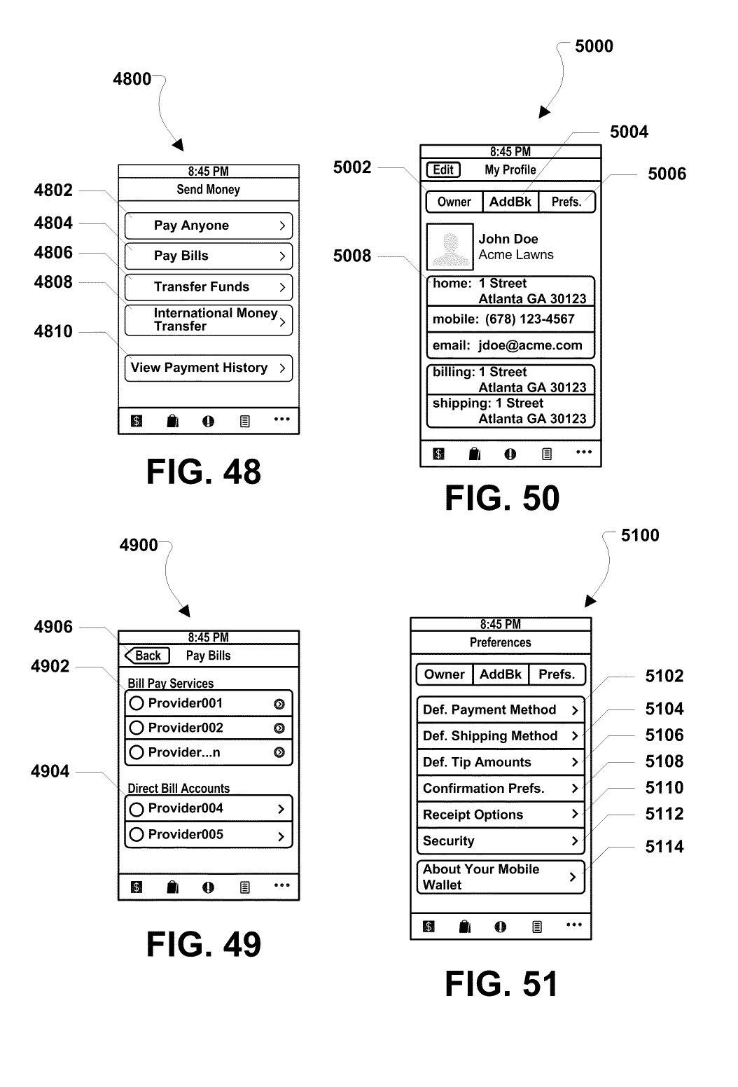

Referring now to FIG. 48, a send money screen 4800 is illustrated. The send money screen 4800 may be accessed by selecting the send money option 3908 (FIG. 39) from the more screen 3900 (FIG. 39). The send money screen 4800 may include a pay anyone option 4802, a pay bills option 4804, a transfer funds option 4806, an international money transfer option 4808, a view payment history option 4810, or a combination thereof. The pay/transfer buttons 4802, 4804, 4806, 4808 may be selected in order to pay or transfer money to other accounts. The view payment history 4810 may be selected in order to view a user payment history.

FIG. 49 illustrates a pay bills screen 4900 that may be accessed by selecting the pay bills option 4804 (FIG. 48) from the send money screen (FIG. 48). The pay bills screen 4900 may include a bill pay services window 4902 and a direct bill accounts window 4904. Each window 4902, 4904 may include a list of providers to which payments may be made. The pay bills screen 4900 may also include a back button 4906 that may be used to return to the send money screen 4800 (FIG. 48).

Referring to FIG. 50, a profile screen is depicted and is generally designated 5000. The profile screen 5000 may be accessed by selecting the profile option 3910 (FIG. 39) from the more screen 3900 (FIG. 39). A shown, the profile screen 500 may include an owner information button 5002, an address book button 5004, a preferences button 5006, or a combination thereof. When the owner information button 5002 is selected, an owner information window 5008 may be displayed. The owner information window 5008 may include an owner name, a home address, a mobile number, an email address, a billing address, a shipping address, or a combination thereof. The profile screen 5000 may also include an edit button 5010 that may be selected in order to edit the owner information.

FIG. 51 illustrates a preferences screen 5100 that may be accessed by selecting the preferences button 5006 (FIG. 50) at the profile screen 5000 (FIG. 50). The preferences screen 5100 may include a default payment method option 5102, a default shipping method option 5104, a default tip amount option 5106, a confirmation preferences option 5108, a receipt options 5110, a security option 5112, or a combination thereof. The default payment option 5102 may be used to set a favorite credit card or account as a default method of payment. The default shipping method option 5104 may be used to set a default shipping address and a default shipping method. Further, the default tip amounts option 5106 may be used to set default gratuity amounts to be used at restaurants and other service industries that accept tips. The confirmation preferences option 5108 may be used to adjust which actions require confirmations. The receipt options 5110 may be selected in order to manage how receipts are organized. The security option 5112 may be used to change a login pass code and other security settings. As shown in FIG. 51, the preferences screen 5100 may also include an about your mobile wallet option 5114 that may be selected in order to see details about the mobile wallet associated with a particular mobile device.

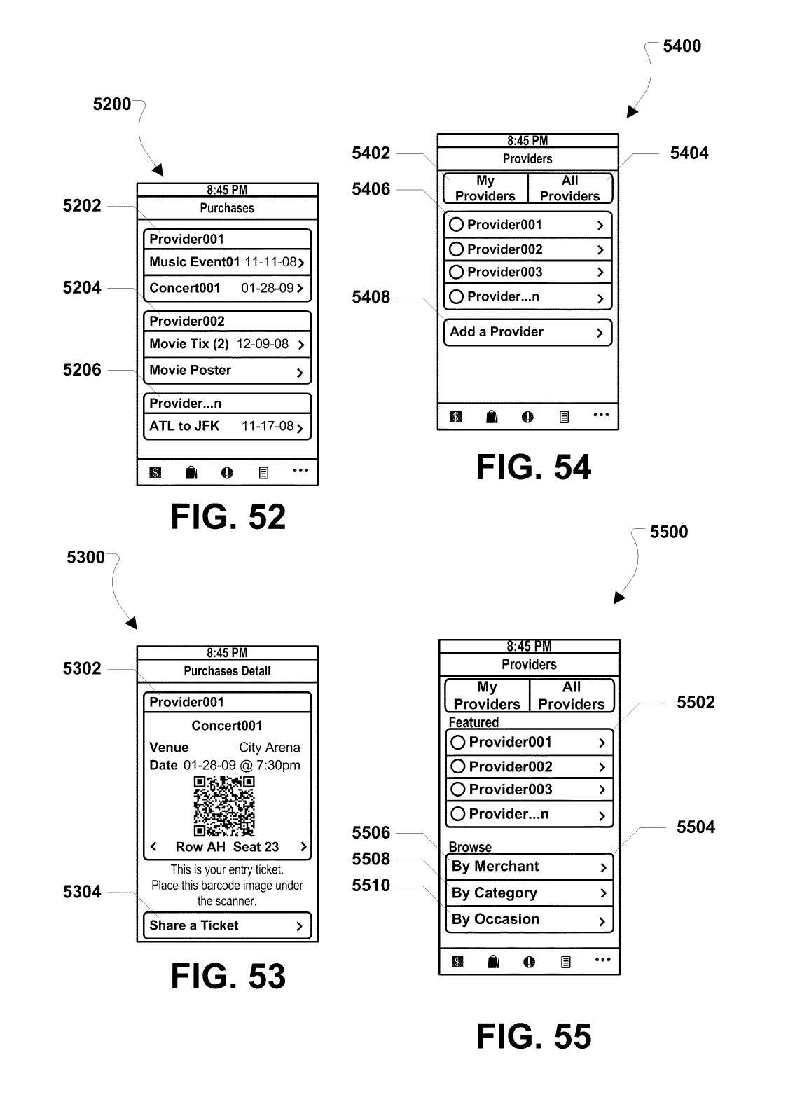

Referring now to FIG. 52, a purchases screen is shown and is generally designated 5200. As shown the purchases screen 5200 may include a first provider window 5202, a second provider window 5204, and an Nth provider window 5206. Each provider window 5202 may include one or more items purchased from that particular provider. It is to be understood that the list of items purchased are not receipts, but actually a representation of an item actually purchased.

When a user selects a particular purchase from a provider window 5202, 5204, 5206, a purchase detail screen 5300, shown in FIG. 53, may be displayed. The purchase detail screen 5300 may include provider window 5302 that may include details regarding a particular purchase, e.g., a concert ticket. Such a purchase detail 5300 may include a venue indicator, a date, a bar code, or a combination thereof. The purchase detail screen 5300 may also include a share button 5304 that may be selected in order to share a particular item purchased by sending a similar item to a friend's mobile wallet.

FIG. 54 illustrates a providers screen, designated 5400. As shown, the providers screen 5400 may include a my providers button 5402 and an all providers button 5404. When the my providers button 5402 is selected, a providers list 5406 may be displayed and may include a list of the providers associated with the user mobile device. The providers screen 5400 may also include an add a provider button 5408 which may be used to find and save providers to the mobile wallet.

When the all providers button 5404 is selected, a featured providers window 5502, shown in FIG. 55, may be displayed. The featured providers window 5502 may include a list of featured providers. Further, a browse window 5504 may be displayed when the all providers button is selected. The browse window 5504 may include a browse by merchant option 5506, a browse by category option 5508, a browse by occasion option 5510, or a combination thereof.

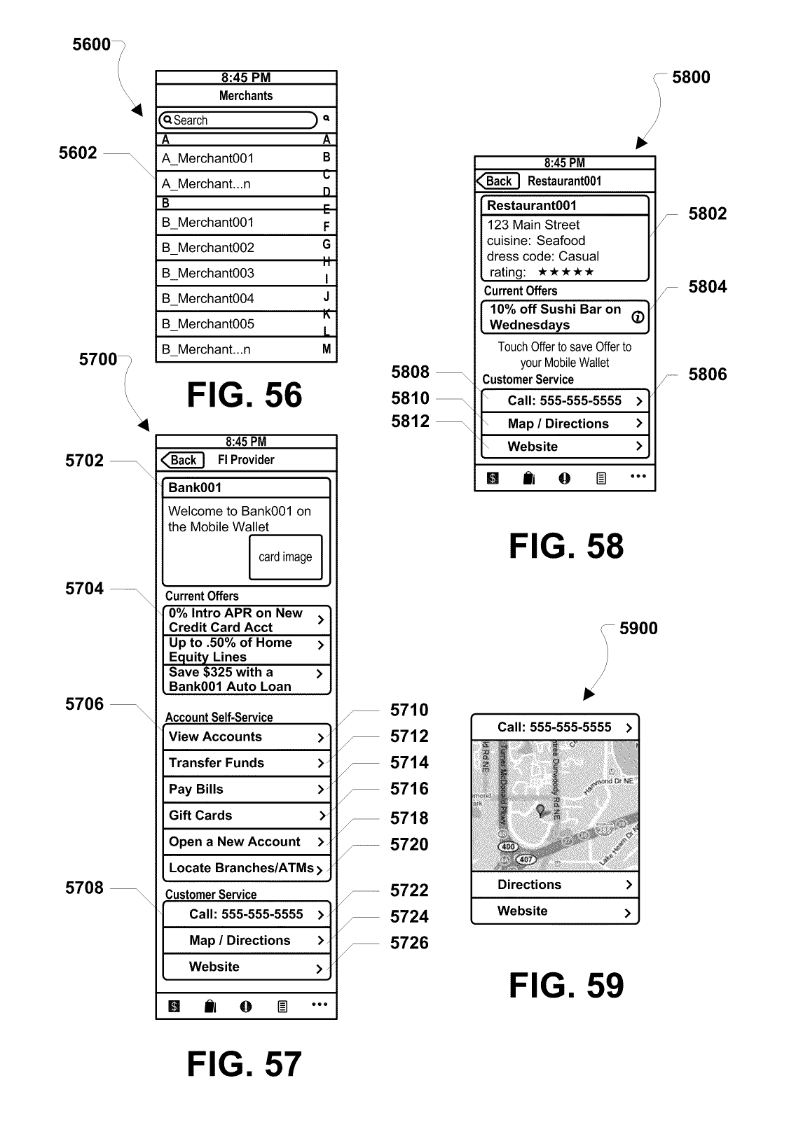

When the browse by merchant option 5506 is selected, a merchants screen 5600, shown in FIG. 56, may be displayed. The merchants screen 5600 may include a merchant list 5602 displayed alphabetically. The merchants screen 5600 may also include a search input field 5604 in which a search term may be input by the user.

When a particular provider is selected from the merchants screen 5600, a provider details screen 5700, shown in FIG. 57, may be displayed at the mobile device. The provider details screen 5700 may include a provider window 5702, a current offers window 5704, an account self-service window 5706, a customer service window 5708, or a combination thereof. The provider window 5702 may include details about the provider. The current offers window 5704 may include one or more offers currently offered by the provider. The account self-service window 5706 window may include a view accounts option 10, a transfer funds option 5712, a pay bills option 5714, a gift cards option 5716, an open a new account option 5718, a locate branches/ATM option 5720, or a combination thereof. The view accounts option 5710 may be used to monitor account balances and view recent transactions. The transfer funds option 5712 may be used to manage account balances. The pay bills option 5714 may be used pay bill directly from the mobile device. The gift cards option 5716 may be used to buy, add, and get gift card balances. The open a new account option 5718 may be used to open a new checking, savings, or credit account. Further, the locate branches/ATMs option 5720 may be used to get a map to nearest bank branches and ATMs.

In a particular aspect, the customer service window 5708 may include a call option 5722, a map/directions option 5724, a website option 5726, or a combination thereof. The call option 5722 may be used to call customer service. The website option 5726 may be used to access a customer service website via the mobile device.

FIG. 58 illustrates a restaurant provider screen 5800. The restaurant provider screen 5800 may include a restaurant details window 5802, a current offers window 5804, and a customer service window 5806. The restaurant details window 5802 may include details about a particular restaurant, e.g., an address indicator, a neighborhood indicator, a cuisine indicator, a dress code indicator, a rating indicator, or a combination thereof. The current offers window 5804 may include current offers from a particular window. The customer service window 5806 may include a call option 5808, a map/directions option 5810, and a website option 5812. When the map/directions option 5810 is selected, a map screen 5900, shown in FIG. 59, may be displayed.

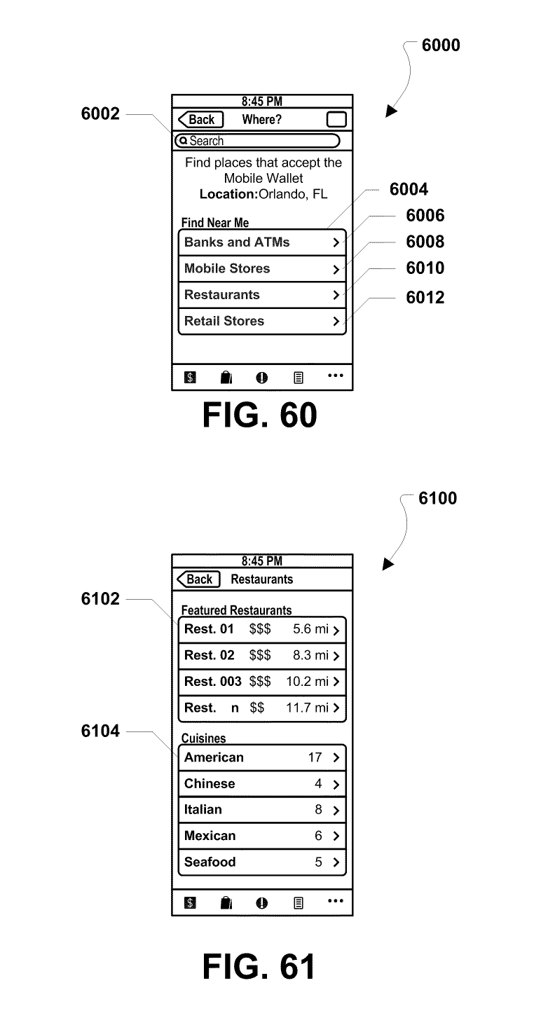

Referring now to FIG. 60, a where screen is shown and is generally designated 6000. The where screen 6000 may be accessed by selecting the where option 3916 (FIG. 39) from the more menu 3900 (FIG. 39). The where screen 6000 may include a search input field 6002 that may be used to enter a query. The where screen 6000 may also include a find near me window 6004. The find near me window 6004 may include a find banks and ATMs option 6006, a find mobile stores option 6008, a find restaurants option 6010, a find retails stores option 6012, or a combination thereof. The find banks and ATMs option 6006 may be used to locate banks and ATMs near the address of the user of the mobile device. The find mobile stores option 6008 may be used to locate mobile stores, e.g., on the Internet. The find restaurants option 6010 may be used to locate restaurants near the address of the user of the mobile device. Further, the find retail stores option 6012 may be used to locate retail stores near the address of the user of the mobile device.

When the find restaurants option 6010 is selected, a find restaurants screen 6100, depicted in FIG. 61, may be displayed. The find restaurants screen 6100 may include a featured restaurants window 6102 and a cuisines window 6104. The featured restaurants window 6102 may include a list of restaurants near the address of the user of the mobile device. The restaurants may be listed based on a distance from the user address. The cuisines window 6104 may list the various cuisines of the restaurants near the user address. The cuisines window 6104 may be organized alphabetically.

With the configuration described herein, the system and method disclosed herein may be used to provide a mobile wallet at a mobile telephone. The mobile wallet may be used to manage multiple accounts at a mobile telephone. Further, the mobile wallet may be used to provide relatively easy shopping at a mobile store.

In a particular aspect, the mobile wallet may provide a flexible and efficient way to search providers by name or by using a unique short code. Provider searches may be filtered based on parameters such as new or featured. A mobile wallet user may enter a unique provider code that may not only provide a relatively quick way to locate a provider, but also be linked with cross-media promotions. Alternatively, a user may enter a provider name, e.g., a full name or a partial name in order to find a provider. To make things as easy as possible for the user, a flexible auto-complete suggestion mechanism may be provided. Further, a user may filter a search based upon provider parameters such as: new, featured, type, category, function, etc.

In another aspect, users may select or view providers by a number of searchable parameters. For example, users may browse providers by function. Further, users may browse providers alphabetically by name. Also, users may browse providers by type, e.g., banks, credit unions, merchant/retailer, membership, biller, etc. Users may also browse all providers, recently used providers, saved providers, featured providers, or a combination thereof. In a particular aspect, the system may monitor provider usage and a user may browse the providers based on popularity. Also, users may browse new providers or browse providers by category, e.g., gift cards, clothing, electronics, music, etc.

A user may search providers based upon a specific, desired function. Selecting a provider may direct a user to a my accounts screen or in the case of an individual provider, to a provider home screen. Alternatively, selecting a provider may take a user directly to a function screen within an individual Provider. In another aspect, a user may browse by buy gift cards, by get gift card balance; by get offers; by get loyalty/rewards account, or a combination thereof.

The system and method disclosed herein also allows a user to save providers in a mobile wallet for ease of reference and use in the future. A user may save individual providers. Also, a user may save a result set, i.e., a group of providers returned in response to a search. A user may set the system to automatically save a provider if the user performs any function, or functions, with the provider. A user may delete a provider which may cause a provider to be un-enrolled from the mobile wallet. However, the deleted provider may be re-added at a later stage. Deleted providers may be archived for potential “undos” in the case of accidental deletion or for archival reference.

In a particular aspect, the system and method may provide a relatively flexible, easy, and intuitive way to enroll a user with a Provider and to track the enrollment within the Wallet. Initially, a minimum amount of user information to establish identity may be collected or a light-weight enrollment process may be performed to minimize enrollment abandonment. The mobile wallet enrollment process may include enabling provider accounts, activating payment accounts, establishing a user profile and preferences, etc. A user may create a password to be used online and a user identification.

The mobile wallet allows a user to easily add one or more provider issued accounts to the mobile wallet or perform maintenance on existing provider accounts. After enrolling a provider in the wallet, a user may enroll or add accounts issued by the provider. The user may provide account details for the account the user would like to enroll. The provider may determine which account details are required to identify the account, e.g., account number, PIN, or other parameter(s) required by provider. The user may further provide additional information to authenticate with the provider, including but not limited to online account credentials, account PIN/Password, mother's maiden name, etc. Since the physical possession of the phone provides stronger (yet still soft) authentication than on-line, a light-weight authentication may be provided to minimize usage friction. However, a stronger authentication may be provided to adapt to stricter security standards of many providers.

After provider accounts are enrolled, and depending on the wallet server's interface with the provider, a user may be required to perform maintenance on the accounts to ensure they remain active in the mobile wallet. In a particular aspect, a user may edit the name on an account to bring it current with the provider's records. Further, a user may update an expiration date to match a current expiration date. Also, a user may update additional account details as required by the provider or by the wallet server.

After a provider accounts is activated, a user may view the provider account and the details associated with the account. After a provider account is enrolled, a user may remove it from the wallet. However, an archival record of the account's existence in the mobile wallet may be provided.

After a provider is enrolled and eligible provider accounts have been successfully added to the wallet, a user may activate the eligible accounts to be used as payment accounts. A user may activate a payment account from the provider's landing experience, i.e., how the provider initially represents itself to a visiting user. The user may also activate a payment account from a list of all eligible payment accounts or from a “trigger” screen where a payment account is required to complete a process, e.g., checkout—select payment method.

In a particular aspect, a user may be presented with a list of all enrolled provider accounts that are eligible to be activated for payment. Accounts already activated for payment may be identified. After selecting an eligible account, the user may activate the account for payment. The process for activating an account for payment may vary depending on the wallet server interface with the provider. A user may not be required to enter account information. The account information may be supplied through an API. However, the user may be required to provide a card verification number.

A user may select an individual account for activation or multiple accounts for activation. If the system identifies additional eligible provider accounts, the user may be allowed to initiate the activation process for all eligible accounts. Depending on the interface between the wallet server and the provider, the user may be required to enter all or some account information. The wallet server may store all user entered account data with the exception of the card verification number (CVN). Where account details are pre-populated, the user may view the pre-populated information but may not modify it. The user may also supply missing required account information, e.g., card/account number, card expiration date, name on card/account, billing address, phone number, etc. In certain situations, a user may enter a CVN to support account verification with the provider and/or generation of a pre-authorization transaction to verify the account. The wallet server may provide examples of where to find the CVN, i.e., based on the card type. A user may optionally save an account billing address to his or her address book. Also, a user may optionally designate an account as his or her default payment account. Further, a user may view the provider's terms of service and may need to confirm acceptance to proceed. A user may also confirm that an account should be activated for payment.

After a payment accounts is activated, a user may view active payment accounts and see the details associated with the account. For example, a user may view a card/account number, card expiration date, name on card/Account, CVN, customer service phone numbers, supported ATM networks, and other information related to the account such as billing Address and billing Phone. By providing such card details, the mobile wallet may be used as a replacement for a physical wallet. Further, by providing easy access to account details, a user may to store plastic cards and use the mobile representation of the cards when making purchases, e.g., online, over the phone, and some point of sale.

In a particular aspect, after a payment account is enrolled, a user may be required to perform maintenance on the payment account to ensure the account remains active in the wallet and is accepted for payment. The user may edit an expiration date to match a current expiration date. Further, the user may edit the name on an account to match the current name on a card on record with the provider. The user may also update the billing address to match the current billing address on record with the provider.

After a payment account is activated, a user may de-activate it. The account will no longer be available as a payment method for purchases. However, the account may be re-activated through the activate payment account process to become available for payments in the future.

In a particular aspect, a user may determine the display order for payment accounts. This setting may control how payment accounts appear in the active payment accounts list, at checkout, or on any screen where only payment accounts are listed. The user may select a payment account and promote/demote the account to any position within the payment account stack. The user may repeat this process with one or more accounts until complete. Further, the user may select a pre-defined sort order, e.g., by account type, by available balance, by provider, etc. However, a user may elect to always display a given provider's accounts first at checkout when purchasing from that provider. This ensures that the provider's gift cards, credit card, debit cards, and/or rewards accounts always appear at the top of the list giving the user the opportunity to use those first for payment. A user may optionally designate an account as the default payment account. This account may be automatically selected for payment regardless of its position in the payment account list display order.

The system and method provided herein also enables providers to sell products to users through the mobile wallet. The system and method enables the purchase of physical goods (virtually any product), mobile downloadable content (music, wallpaper, images), and over-the-air deliverable tokens (e-tickets, access codes, license keys). In addition, the system and method may capture delivery information to ensure fulfillment of the order, may support real-time order status, and may allow users to save purchase confirmations, receipts and tokens in a durable and reliable manner.

The system and method further provides product discovery to enable the user to find products in the mobile wallet. Each Provider may have one or more catalogs for products. Products may include various searchable parameters associated with them, including, but not necessarily limited to: category, type, featured, occasion, gift cards, new, popularity, price, etc. A user may also search or view products via various search dimensions including: browse by category, type, featured, occasion, gift cards, new, popularity, price, price range, etc. A user may also search or view products based upon keyword matches, filters, or a combination thereof. After selecting a product, a user may be presented with product details.

The system and method also provides a buy now feature that allows a user to enter a buy now code to find a product for purchase. The buy now feature provides users with relatively easy access to individual products, while allowing providers to continue marketing products via print, television, radio, and online advertising. A user may access a product details page for a product by entering a buy now code, e.g., 5787. Also, a user may access a product details page for a product by scanning a buy now barcode. Further, using a NFC capable handset, a user may access a product details page for a product by tapping an NFC smart tag. Product codes may be determined by the providers. Providers may use existing product codes or define custom buy now product codes. Alpha-numeric buy now codes may be used. However, numerical buy now codes may limit input errors and ensure an acceptable user experience. The system may further support product codes that include a provider identifier, e.g., 300-5787.

The system and method provides a featured products feature that allows a user to view a set of featured products and make a selection for purchase. This provides a way for providers to market to and to attract users to their catalog(s), service(s), or a combination thereof. A custom featured products may be provided to allow providers to establish multiple, custom featured products groups. Providers may define multiple custom groups of featured products, e.g., gift cards, weekly specials, deal of the day, etc. Providers may designate the menu label for each group. Presentation of the featured products may be standardized or may be custom. Further, the products featured may be chosen by the provider and may be defined in the product catalog. Product images and the order in which the products are displayed may be determined by the provider. Also, providers may be able to control the display of the featured product group by customer segment.

A user may view available featured product groups by name, e.g., new, featured, for her, etc. Featured product groups may be displayed to all users or may be segmented by user type. If shown a featured product group, the user may select the group and proceed to view the featured products. The featured products screen may include the summary information about the featured products. Summary information may include: image, product name, product category, price, etc. The summary information may be defined by the provider. A user may select a product to view product details. Buy gift cards may be made available to providers as a pre-defined featured product group. The Provider may use this group as defined by assigning gift card products to the group, or may update/disable the group. A user may select buy gift cards to view the featured gift card products. A gift card products screen may display summary information about the featured gift cards. The summary information may include: image, product name, card types (plastic and/or e-card), etc. The summary information may be defined by the Provider. A user may select a card to view product details.

In a particular aspect, the product details screen may provides details about the selected product and may allow the user to select product attributes. The product details screen may include a brief product description, an image of the product, shipping timing and product inventory status, terms and conditions (as determined by the provider and stored in the product catalog), or a combination thereof. The product details screen may also include product attribute selection if more than one attribute option is available. Further, the product details screen may include a product quantity field, e.g., presented as a numeric drop down field, and a product type selection if more than one available.

In a particular aspect, the product details screen may also include gift card denominations that are chosen by the provider and that may be a continuous set of numbers between 1 and 10000+ or a discreet set of integers within the same range. The denominations selected by the provider may determine the user interface. The denominations may be presented as a text box, e.g. a range of 10-1000 with validation limits of 10-1000. Also, the denominations may be presented as a drop down menu, e.g. 25, 50, 100, 250, 500, etc., listed in a drop down box. A provider may select both options as long as the lower limit and upper limit are the same. For example: 10, 50, 100, 200 or 10-200 may be shown as a drop-down and a text box. The product details screen may also include business rules, i.e., instructions for users about product thresholds such as product amount limits or quantities. A user may enter or select product attributes and then, proceed to checkout.

The system and method described herein also includes a wish list function in which the user may select certain products of interest for later action and/or review. A user may save products directly to the wish list from multiple sources, including searched/browsed products, featured products and gift cards. A user may browse wish list items based on several different parameters, such as date saved, provider, product category/type, price, etc. A user may move immediately to purchase from the wish list. Saved products may be removed per a configurable expiration/aging policy or manually. Further, a user may elect to have a reminder or alert to fire based upon pre-defined criteria such as event date, product release/availability, restocking status, etc. Also, a user may export the wish list to others/self via several communication/community mechanisms such as wallet-to-wallet (w2w), text message, E-mail, My Space/FaceBook, etc.

The system and method also provides checkout functionality. After reviewing product details and selecting required product attributes, a user may elect to purchase the product by proceeding to checkout. The user may select a payment account from any active payment accounts supported by the provider. The user may provide additional payment account verification as required. A user may accept a default payment method or select a payment method. If the user does not have active payment accounts, and taking into consideration user's eligible payment account status, the system may provide an appropriate option, e.g., accept default payment account, activate payment account, edit payment account, apply for credit, enroll provider, etc. If a user has established a default payment method, then no action is required to accept the default payment method. A user may select a payment account from any active payment accounts supported by the provider. Payment accounts may be displayed in order based on user preferences or based on a default sort order such as available balance. If the payment method is expired, the user may be taken to the edit active payment account screen for the selected account. The order may be saved until the user returns to the transaction.

In a particular aspect, the user may select activate payment account which may take the user to the view all eligible payment accounts screen. The user may activate a payment account to proceed. The system may save the order until the user returns to the transaction. If no eligible payment accounts are found, the user may be presented with the following options: enroll provider, add and activate payment account, and apply for credit. Selecting the enroll provider option may take the user to the find provider screen. The user may complete the enrollment process and activate a payment account to proceed. The system may save the order until the user returns to the transaction. Selecting the add and activate payment account option may direct the user to the saved providers screen. The user may enroll and activate a payment account to proceed. The system may save the order until the user returns to the transaction. Selecting the apply for credit option may direct the user to the credit application for the current provider. The user may complete the application process and receive a confirmation of credit approval to proceed. The system may save the order until the user returns to the transaction.

After selecting a payment method, the user may be required to provide additional payment method verification details as required by the provider. If required by the provider, and if a debit card or credit card is selected as a payment method, the user may need to provide the card verification number (CVN). A provider may require CVN on the user's first purchase with the provider, or on every purchase. The system may provide example of where to find the CVN, i.e., based on the card type. If the user is allowed to store CVN on the phone, system may allow the user to view it at this point. If required by provider, the user may need to provide an e-mail address. This may be pre-populated and/or selected from address book. Further, if required by the provider, the user may need to enter billing address zip code. This may be required as a fraud prevention step and would be in addition to the billing address information that may be automatically provided by the system. The provider may require that the user provide this information. Additionally, if required by the provider, the user may need to enter a billing address phone number. This may be required as a fraud prevention step and would be in addition to the billing address information that may be automatically provided by the system. The provider may require that user provide this information.

In a particular aspect, the user may choose to split the purchase price across several payment methods, e.g., a standard payment plus a gift card or gift cards, multiple standard payment methods, etc. If the user selects a gift card as the payment method, the system may determine if the gift card has sufficient balance to cover the purchase. If not, the system may prompt the user for additional payment method. If the user selects one or more gift cards as the additional payment method, the system may apply any gift card payments first and charge the remainder to the other payment method. If the user selects a credit/debit card as the additional payment method, the system may allow the user to designate the amount to be taken from each payment method. This step may be completed once the final price is calculated.

A user may elect to add several elements of personalization to the order during the checkout process. This could be a custom message written by the user, or a pre-written message that the user selects. Additionally, the user may want to select a gift wrap and/or gift packaging option. Gifting and personalization may be offered to the User as an up-sell/cross-sell. If the purchase is a gift, the system may direct the user to the gift personalization screen. At the gift personalization screen, the user may enter a custom greeting, message body and/or closing message. The user may select a pre-written message. Also, the user may select gift wrapping/packing options. Further, the user may select or enter a return/sender address. This is intended to be the address of the person who is sending the product. In general, ensures that the recipient recognizes the sender.

In order to enter delivery information, the user may be directed to a delivery information screen that is specific to the type of product selected. For physical delivery, the user may select a shipping address from the address book, find an address, or manually enter a new shipping address. The user may also elect to have the product delivered to a provider location for pick-up. If the user has established a default shipping address, then it should be pre-populated. No action may be required to accept the default shipping address. If the provider requires that the product be shipped to the billing address of the payment account, this will override the user's preference. The product may be shipped to the billing address of the payment account. This may be the only option supported by the provider. Conversely, the product may be shipped to the address selected or entered.

In a particular aspect, the user may find a shipping address by supplying a house number and zip code. The user may select the address from the result set. Particularly, the user may enter the recipient's house number and zip code and selects submit. The user may receive a list of possible addresses located in that zip code. If the list contains the correct address, the user may choose the correct address by navigating to the address and selecting it. If no match is found, the user may proceed to enter required address information. Additionally, in store pickup may be supported and the user may elect to pick the product up at a provider location.

In another aspect, the user may enter/edit required address information. The user may manually enter address information or edit system provided address information. Required fields may be based on provider preferences, e.g., recipient name, recipient company, recipient street 1, recipient address line 2, recipient city, recipient state, recipient zip, recipient country, recipient telephone number, recipient e-mail address, etc. To ensure that the addresses received are legitimate and properly formatted, the system may verify an address at the point of data input.

After providing shipping information, and if the user has established a default shipping method, no action should be required to accept the default shipping method. After providing shipping information, the user may select a shipping method from those supported by the provider. e.g. USPS standard, USPS priority, USPS priority with delivery confirmation, USPS express, common carrier ground, common carrier second day, common carrier next day, etc. The user may be presented with the next available ship date. This is typically the next business day and represents the earliest date that the items will be shipped. It is contingent upon Payment Account authorization.

When supported by the provider, the user may select a future shipping date for the product. This feature may allow the user to place an order for a future holiday, a birthday, or an event and schedule the item to be sent just before that event. The user may receive an approximate delivery time so that the delivery date may be estimated. Once a shipping address and shipping method are selected, the user may have the option to calculate the shipping costs and edit shipping method.

In the case of a mobile delivery, if the purchase is a gift, the user may provide the mobile number of the recipient. Otherwise, the system may automatically ask the user to key a recipient's mobile number. Alternatively, the user may select a mobile number from an address book. In the case of electronic delivery, if the purchase is a gift the user may provide the e-mail address of the recipient, otherwise the system may automatically ask the user to key a recipient's e-mail address. Conversely, the user may select a recipient e-mail address from an address book

During checkout, the user may enter one or more promo/coupon codes. If the provider elects to do so, any relevant offers or coupons that reside in the user's mobile wallet should be automatically detected and incorporated into the order. In the case of a saved order being re-opened and progressed, this check should occur again, in order to incorporate any new offers or coupons that are relevant. Prior to submission, the user may review the various elements of the order. The user may then edit one or more of the order elements. When review is complete, the user may confirm by submitting the order. The user may also have a final opportunity to enter any promotional codes.

At any time during the checkout process prior to order submission, a user may edit any element of the order, without losing the work they have already accomplished. Further, a user may save a transaction at any point in the process after proceed to checkout. A user may submit an order and the system may process and validate all elements immediately, including verification of payment method, in order to return order confirmation, or an error or a failure, status with details. If errors occur, the user may be allowed to cure the errors. Once an order submission is complete, the user may receive an order confirmation that displays a unique identifier for the transaction, as well as a tracking number if it is available at that point. This may be stored elsewhere as well for later reference.

Another feature provided by the system and method includes an orders and receipts feature. The orders and receipts feature allows a user to save and reference orders, receipts and tokens. Stored order confirmations may allow the user to review, track and, if necessary, trouble-shoot any orders. Receipt storage may provide a durable, digital mechanism for users to track their purchases. Tokens refer to records that represent digital purchases that require an alphanumeric code or a graphical code, e.g. a 2D bar code, to redeem or re-redeem, whether the ultimate product or service is on- or off-line.

The user may browse orders and receipts based upon several different order parameters, such as: by date, provider, delivery address, payment account, recipient, etc. Further, the user may view order status including order origination, shipping status (if applicable) and delivery method. The user may view various elements of their orders, including: order status, tracking number (if Available), delivery address, etc. In the case of mobile or electronic delivery of orders, a user will have a more limited view of the relevant order elements, including: order status, delivery address (Mobile Phone/E-mail), etc.

In the event a separate receipt is not issued beyond the order confirmation, the user or provider may flag an order confirmation as a receipt. Also, in the event a separate token is not issued beyond the order confirmation, the user or provider may flag an order confirmation as a token. A user may choose to manually export order, token, or receipt data in one of several standardized formats, e.g., for potential import into a spreadsheet, for printing, etc. Save items may be removed per a configurable expiration policy, an aging policy, or manually.

The system and method described herein may allow providers to extend the reach of loyalty programs and membership programs to mobile devices. This may allow providers to drive real-time information to existing program member to increase spending, reduce churn, shift spending to higher margin products, and will support the acquisition of new customers. A custom program framework may allow providers to define multiple, custom programs areas. Custom program groups may be displayed to all users or may be segmented based on user type. Program details may be supplied by the provider and may be specific to the user. User specific information may be provided to program members; and general program information may be provided to non-members. A user may click to call the member service number specific to the program. If not currently enrolled, a user may enroll in the program via the mobile wallet. If the enrollment involves the delivery of user details to the provider, the user information that will be sent to the provider may be confirmed on-screen and the user may confirm the submission. An in-wallet, e-mail, or text message may be sent to the user to confirm that the enrollment has been sent.

In a particular aspect, the system and method may further include a flexible offers framework. The offers framework may allow providers to market to users, promote strategic products, and incentivize high-value behavior. A user may view list of relevant offers targeted based on based on behavior, demographics, opt-in information, or a combination thereof. A user may view offer details, e.g., offer title, description, expiration information, limitations, conditions, information on transferability, etc. Further, a user may search the offers by any offer parameter or by keyword. A user may enter an offer code to find an offer. The offer code may be a unique code and may facilitate cross-media campaigns

Users may save offer in the mobile wallet and the offers may be automatically detected during the checkout process. Users may also elect to send offers to e-mail addresses. For transferable offers, a user may share the offer by sending the offer via wallet-to-wallet communication, text messaging, or e-mail. The user may have multiple means to respond to offers that appeal to them. For example, they should be able to buy the product directly, click to call, accept the offer (thus storing it in their Wallet) or redeem the offer directly. Accepting an offer may cause the offer to be saved into the mobile wallet. If the offer is redeemable at checkout it should be automatically detected during the checkout process. If the acceptance involves the delivery of user details to the provider, the user information sent to the provider may be confirmed on-screen and the user may confirm the submission. An in-wallet, e-mail, or text message may be sent to the user confirming that the inquiry has been sent. The offer may further include a click-to-call number that may be a phone number configurable by the provider.

Redeeming an offer may generate a token that may be stored in the wallet and used at the POS to redeem the offer. The token may store the relevant details as well as a either a unique offer Identifier or a graphical redemption image, e.g., a 2D bar code. Selecting buy now should direct the user to the product details page for the offered product. Promotional pricing or coupon may be pre-populated and applied at checkout. A provider may tie the offer to the use of a specific payment method and this limitation may be enforced at Checkout. If an offer results in a zero dollar transaction, the user may still receive an order confirmation. Expired offers may be removed in an automated fashion, potentially with the option to have a reminder, or alert, triggered immediately prior to expiration. A user may also elect to remove offers at any time.

The system and method described herein also provides gift card services that may allow a user to get gift card balances, save gift cards, and refresh, reload, or top up the balance on a saved gift card. A user may request a gift card balance by: entering a gift card number, entering a gift card PIN, or supplying other gift card details. A user may enter the gift card number and the system may display a provider specific example showing where to locate the card number. For maximum usability, the system may support pre-populating a portion of the card number or only require the user to enter the last X digits of the card number. Further, a user may enter the gift card PIN number and the system may display provider specific examples showing where to locate the PIN number. Depending on the provider's requirements, a user may be required to provide other gift card details to obtain a balance. A gift card balance response may include a card number, a PIN number, a balance, a provider marketing message, etc.

After gift card details have been entered and a balance successfully obtained, a user may save a gift card to the mobile wallet. The system may store the last balance pulled for the gift card, but the provider may determine if gift card balances should automatically be refreshed. If a balance is not automatically refreshed at login, a user may manually request to refresh the gift card balance. If supported by the Provider, a user may click to call an IVR/VRU system to obtain a balance or access customer service.

In a particular aspect, the system and method described herein also provides for account acquisition that may allow a user to open or request accounts from the provider. A user may complete a credit application to apply for a provider's credit card. If approved, the account may be immediately provisioned and enabled in the mobile wallet. A user may view and choose from the provider's available card products and designs. To complete an application, the user may provide requested application information. Some of this information may be pre-populated from the user's mobile wallet profile. For example, this information may include name, address, phone, SSN, income, date of birth, drivers license number and state, credit amount requested, etc. A user may review and acknowledge acceptance of provided disclosures and terms of service. Further, the user may submit the credit application.

In response to the user submission, the system may present the user with a confirmation that the application was received. If an instant decision is available, the user may receive an immediate approval, a soft decline, a hard decline, or some other status or response. System may to support provider defined responses which may include a customer service number to call to complete the application or to request more information on the decision. When a real-time decision is not available, a user may check the application status after receiving an alert or at any time by requesting a status update.

If the credit application is approved, the user may add the payment account to the mobile wallet and begin to transact in the mobile wallet. The user may request to add another account, e.g., checking, savings, etc., to an existing relationship.

The system and method herein may provide usage analytics which will assist providers in targeting relevant and compelling messages to the users. The system may track and analyze how users are searching and for what they are searching. The system may track user location data to analyze user geographic patterns for location-relevant targeting. The system may also track the offers that are viewed and ultimately accepted or abandoned. Further, the system may track behavior through the checkout process in order to predict what causes successful or unsuccessful completion of the checkout process. Also, the system may track and analyze how products are viewed and exited, including source tracking as there are multiple ways to get to product detail pages. The system may also track wish lists, since the users are volunteering what products or services are most interest to them. Further, tracking the most/least frequently accessed account maintenance features may provide valuable usability insights.

The system and method described herein may also include a store locator that may allow a user to find a provider's locations in a given locale or specific to the user's position. The wallet may automatically identify stores close to the User's present location. The user may be presented with a list of store locations within a given distance of her current location. The user may change increase or decrease the range. Further, the user may select a location and choose to view text-based directions within the mobile wallet. The user may also select a location and choose to launch a navigation application to view a map with turn-by-turn directions. The user may also search store locations by zip code or city and state. The user may be presented with a list of store locations within a given distance of the provided zip code and the user may change increase or decrease the range.

The system and method herein also provides a user profile that may allow a user to record personal information for later use when making purchases, applying for credit, accepting offers, enrolling in programs, requesting information, or submitting contest/sweepstake entries. The user profile may also allow the user to view and maintain information automatically gathered by the system over time i.e., address book entries, credentials, and usage and interest data. Information recorded in the user profile will be pre-populated and/or made available for selection on form screens and submissions whenever possible to simplify and streamline the mobile experience for the user. The user may record and maintain personal information for use in mobile commerce and financial services activities throughout the mobile wallet. Further, the user may view and edit personal information including: name, sex, date of birth, mobile phone, land phone, e-mail address, etc.

The user may record and maintain shipping addresses, including recipient name and phone, for use as a billing address and destination address in mobile commerce and financial services activities throughout the mobile wallet. Also, the user may add new address book entries. Addresses may be the user's own addresses or may be those of friends or family members to whom the user may want to send gifts. Address record should include full name, shipping address, and phone number. The user may edit, copy & edit, or remove existing address book entries. Additionally, the user may record and maintain personal preference and interest information such as communication preferences and marketing/product interests. A user may elect to share this information with providers to enhance the mobile commerce and mobile financial services experience.

A user may record and maintain communication method preferences for all notifications, and alerts generated by the mobile wallet. Possible options may include text message, e-mail, in-wallet, secure message, etc. The user may also record and maintain preferences (Opt-In/Opt-Out) for all general and marketing notifications. Example notifications include: order updates and confirmations, shipping confirmations, customer service inquiries, legal notices, new products, research surveys, expiration notices, featured providers, special offers, available to order notifications, etc. A customer service inquiry may include confirmation that an inquiry has been received. The legal notices may include terms and conditions of using the mobile wallet as determined by the user's saved providers and by the wallet server and the carriers. If a user chooses not to receive legal notices in-wallet, or by e-mail or text message, the user may need to check the provider web site to stay updated on provider policy changes. The new product notification may include new product announcements from saved Providers. The new product notifications may be targeted based on past purchases, preferences, etc. Research surveys may include mobile wallet feedback, provider feedback reminders, and other customer surveys. Expiration notices may include expiration notices on active payment accounts, purchased tokens, accepted offers, etc. Featured provider notifications may include new, featured Provider announcements that may be targeted and untargeted as determine by the carrier and the wallet server. Special offer notifications may include notice of new offers, sales, new provider launches, important new mobile wallet features, contests, sweepstakes, and other promotional announcements, as determined by the carrier and the wallet server. Available to order notifications may include notice of when an out-of-stock item is once again available or when a wish list item or highly anticipated items such as new DVDs are officially released and able to be ordered. A user may also provide information about her interests. This information may be shared with providers in the mobile wallet to facilitate promotions, exclusive mobile offers and delivery of information targeted to the users' indicated interests.

In a particular aspect, a user may configure, including opt-out, a setting that controls how the wallet server and the carriers may use and share information collected from activities and interactions in the mobile wallet, e.g. purchase activities, search history, wish lists, viewed and saved offers, and provider relationships. A user may set allowances for specific categories of use or may decline all. Example categories include: marketing, customer service, product recommendations, etc.

In a particular aspect, a user may create and maintain a mobile payment transaction PIN. This may be a mobile wallet level PIN meaning it would not be Provider specific. The Providers would not need to know the PIN or verify it, but would want to know that the wallet server has verified the PIN. A user may set preferences for receiving confirmation messages and receipts. Options should include in-wallet, text message, and/or e-mail. Further, a user may record and maintain credentials for providers. This may be necessary in cases where the user's online credentials must be maintained by the wallet server for continued access. This may allow users who infrequently visit a provider's web site to recall online credentials. A user may establish security preferences for the wallet and change security defaults. Further, a user may override the default PIN retries setting with a user setting. Also, a user may set PIN recovery options. A user may also set out-of-band, i.e., not delivered to the same mobile device, alerts for activities that occur in the mobile wallet. Alert-able activities may include: modifying security preferences, adding or modifying a payment account, completing a mobile purchase, applying for credit, personal profile changes, and adding/modifying a provider.

The system and method may further provide “Shortcuts” to frequently used segments of the mobile wallet. The user may relatively easily save a shortcut to a function from any screen within a function.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of providing a mobile wallet, the method comprising:
displaying a mobile wallet login screen; and
displaying a mobile wallet, wherein the mobile wallet includes at least one of the following: an accounts option, a buy now option, an offers option, a receipts option, and a more option.

2. The method of claim 1, further comprising:
displaying one or more accounts when the accounts option is selected.

3. The method of claim 2, wherein the one or more accounts includes at least one of the following: a bank account, a credit account, a gift card account, and a rewards account.

4. The method of claim 2, further comprising:
displaying account details when the one or more accounts is selected.

5. The method of claim 1, further comprising:
displaying a buy now input screen when the buy now option is selected; and
receiving a buy now code.

6. The method of claim 5, further comprising:
displaying at least one featured product and at least one featured gift card, when a correct buy now code is received.

7. The method of claim 1, further comprising:
displaying one or more offers when an offer is received;
providing a save offer option; and
adding an offer to a saved list, when the save offer option is selected.

8. The method of claim 1, further comprising:
displaying one or more receipts, when the receipts option is selected.

9. The method of claim 8, further comprising:
displaying one or more receipt details, when a receipt is selected.

10. The method of claim 1, further comprising:
displaying a carrier option, a coupons option, a messages option, a send money option, a profile option, a purchases option, a providers option, a where option, or a combination thereof, when the more option is selected.

11. A device, comprising:
means for displaying a mobile wallet login screen; and
means for displaying a mobile wallet, wherein the mobile wallet includes at least one of the following: an accounts option, a buy now option, an offers option, a receipts option, and a more option.

12. The device of claim 11, further comprising:
means for displaying one or more accounts when the accounts option is selected.

13. The device of claim 12, wherein the one or more accounts includes at least one of the following: a bank account, a credit account, a gift card account, and a rewards account.

14. The device of claim 12, further comprising:
means for displaying account details when the one or more accounts is selected.

15. The device of claim 11, further comprising:
means for displaying a buy now input screen when the buy now option is selected; and
means for receiving a buy now code.

16. The device of claim 15, further comprising:
means for displaying at least one featured product and at least one featured gift card, when a correct buy now code is received.

17. The device of claim 11, further comprising:
means for displaying one or more offers when an offer is received;
means for providing a save offer option; and
means for adding an offer to a saved list, when the save offer option is selected.

18. The device of claim 11, further comprising:
means for displaying one or more receipts, when the receipts option is selected.

19. The device of claim 18, further comprising:
means for displaying one or more receipt details, when a receipt is selected.

20. The device of claim 11, further comprising:
means for displaying a carrier option, a coupons option, a messages option, a send money option, a profile option, a purchases option, a providers option, a where option, or a combination thereof, when the more option is selected.

21. A device comprising:
a processor, wherein the processor is operable to:
display a mobile wallet login screen; and
display a mobile wallet, wherein the mobile wallet includes at least one of the following: an accounts option, a buy now option, an offers option, a receipts option, and a more option.

22. The device of claim 21, wherein the processor is further operable to:
display one or more accounts when the accounts option is selected.

23. The device of claim 22, wherein the one or more accounts includes at least one of the following: a bank account, a credit account, a gift card account, and a rewards account.

24. The device of claim 22, wherein the processor is further operable to:
display account details when the one or more accounts is selected.

25. The device of claim 21, wherein the processor is further operable to:
display a buy now input screen when the buy now option is selected; and
receive a buy now code.

26. The device of claim 25, wherein the processor is further operable to:
display at least one featured product and at least one featured gift card, when a correct buy now code is received.

27. The device of claim 21, wherein the processor is further operable to:
display one or more offers when an offer is received;
provide a save offer option; and
add an offer to a saved list, when the save offer option is selected.

28. The device of claim 21, wherein the processor is further operable to:
display one or more receipts, when the receipts option is selected.

29. The device of claim 28, wherein the processor is further operable to:
display one or more receipt details, when a receipt is selected.

30. The device of claim 21, wherein the processor is further operable to:
display a carrier option, a coupons option, a messages option, a send money option, a profile option, a purchases option, a providers option, a where option, or a combination thereof, when the more option is selected.

31. A computer program product, comprising:
a computer readable-medium, comprising:
at least one instruction for displaying a mobile wallet login screen; and
at least one instruction for displaying a mobile wallet, wherein the mobile wallet includes at least one of the following: an accounts option, a buy now option, an offers option, a receipts option, and a more option.

32. The computer program product of claim 31, wherein the computer-readable medium further comprises:
at least one instruction for displaying one or more accounts when the accounts option is selected.

33. The computer program product of claim 32, wherein the one or more accounts includes at least one of the following: a bank account, a credit account, a gift card account, and a rewards account.

34. The computer program product of claim 32, wherein the computer-readable medium further comprises:
at least one instruction for displaying account details when the one or more accounts is selected.

35. The computer program product of claim 31, wherein the computer-readable medium further comprises:
at least one instruction for displaying a buy now input screen when the buy now option is selected; and
at least one instruction for receiving a buy now code.

36. The computer program product of claim 35, wherein the computer-readable medium further comprises:
at least one instruction for displaying at least one featured product and at least one featured gift card, when a correct buy now code is received.

37. The computer program product of claim 31, wherein the computer-readable medium further comprises:
at least one instruction for displaying one or more offers when an offer is received;
at least one instruction for providing a save offer option; and
at least one instruction for adding an offer to a saved list, when the save offer option is selected.

38. The computer program product of claim 31, wherein the computer-readable medium further comprises:
at least one instruction for displaying one or more receipts, when the receipts option is selected.

39. The computer program product of claim 38, wherein the computer-readable medium further comprises:
at least one instruction for displaying one or more receipt details, when a receipt is selected.

40. The computer program product of claim 31, wherein the computer-readable medium further comprises:
at least one instruction for displaying a carrier option, a coupons option, a messages option, a send money option, a profile option, a purchases option, a providers option, a where option, or a combination thereof, when the more option is selected.
